(19) United States
(12) Patent Application Publication
(10) Pub. No.: US 2026/0019912 A1
(43) Pub. Date: Jan. 15, 2026

(54) METHODS, APPARATUS AND COMPUTER-READABLE MEDIUM RELATED TO CONDITIONAL CELL CHANGE

(71) Applicant: Telefonaktiebolaget LM Ericsson (PUBL), Stockholm (SE)

(72) Inventors: Liwei QUI, TÄBY (SE); Jens BERGQVIST, LINKÖPING (SE); Icaro Leonardo DA SILVA, SOLNE (SE); Cecilia EKLÖF, TÄBY (SE); Alessio TERZANI, STOCKHOLM (SE)

(21) Appl. No.: 18/996,037

(22) PCT Filed: Aug. 8, 2023
(86) PCT No.: PCT/SE2023/050790

§ 371 Date: Jan. 17, 2025

Related U.S. Application Data
(60) Provisional application No. 63/370,710, filed on Aug. 8, 2022.

(51) Int. Cl. H04W 36/36; H04W 36/00

(52) U.S. Cl. CPC H04W 36/362; H04W 36/0055; H04W 36/36

(57) ABSTRACT

A method is performed by a user equipment. The method comprises associating a stored configuration for a first serving cell with a condition for executing a cell change procedure to the first cell. The method further comprises, after executing a cell change procedure away from the first cell, monitoring the condition.

### TECHNICAL FIELD

Embodiments of the present disclosure relate to methods, apparatus and computer-readable media relating to communications networks, and particularly to conditional cell change.

### BACKGROUND

### Conditional Handover (CHO)

In the 3rd Generation Partnership Project (3GPP) Rel-16, the conditional handover was standardized as a solution to increase the robustness at handover. In order to avoid the undesired dependence on the serving radio link upon the time (and radio conditions) where the User Equipment (UE) should execute the handover, the possibility to provide Radio Resource Control (RRC) signaling for the handover to the UE earlier was standardized. It is possible to associate the Handover (HO) command with a condition e.g. based on radio conditions possibly similar to the ones associated to an A3 event, where a given neighbour becomes X db better than target (where X is some threshold number). As soon as the condition is fulfilled, the UE executes the handover in accordance with the provided handover command.

Such a condition could e.g. be that the quality of the target cell or beam becomes X dB stronger than the serving cell. The threshold Y used in a preceding measurement reporting event should then be chosen lower than the one in the handover execution condition. This allows the serving cell to prepare the handover upon reception of an early measurement report and to provide the RRCConnectionReconfiguration with mobilityControlInfo (or the RRCReconfiguration with reconfigurationWithSync) at a time when the radio link between the source cell and the UE is still stable. The execution of the handover is done at a later point in time (and threshold), which is considered optimal for the handover execution.

FIG. 1 illustrates a conditional handover execution (involving a UE 102, a serving network node 104 and a target network node 106) and depicts an example with just a serving and a target cell. In practice there may often be many cells or beams that the UE 102 reported as possible candidates based on its preceding Radio Resource Management (RRM) measurements. The network should then have the freedom to issue conditional handover commands for several of those candidates. The RRCConnectionReconfiguration/RRCReconfiguration message for each of those candidates may differ not just concerning the target cell but also e.g. in terms of the HO execution condition (Reference Signal (RS) to measure and threshold to exceed) as well as in terms of the Random Access (RA) preamble to be sent when a condition is met.

At step 110, the serving network node 104 sends User Plane (UP) data to the UE 102.

At step 112, the UE 102 sends a measurement report to the serving network node 104.

At step 114, the serving network node 104 makes a handover decision based on the early report.

At step 116, the serving network node 104 sends an “Early HO” request message to the target network node 106.

At step 118, the target network node 106 accepts the HO, and builds an RRC configuration.

At step 120, the target network node 106 sends an HO Ack message (including the RRC configuration) to the serving network node 104.

At step 122, the serving network node 104 sends a conditional HO command to the UE 102.

While the UE 102 evaluates the condition, it continues operating per its current RRC configuration, i.e., without applying the conditional HO command. When the UE 102 determines that the condition is fulfilled (e.g., at step 124, where measurements fulfill the HO condition, triggering the HO), it disconnects from the serving cell, applies the conditional HO command and connects to the target cell. These steps are equivalent to the legacy handover execution.

At step 126, the UE 102 synchronizes and performs a random access procedure with the target network node 106. When the UE 102 has successfully performed the random access procedure towards the target cell during a conditional handover or a normal handover, it then releases all the conditional reconfigurations that it has stored.

At step 128, the UE 102 sends a HO confirm message to the target network node 106.

At step 130, the target network node 106 sends a HO completed message to the serving network 104. The target cell may then configure new conditional reconfigurations to the UE 102 if it is considered useful.

At step 132, the target network node 106 sends UP data to the UE 102.

### Conditional Primary Secondary Cell (PSCell) Change (CPC) in 3GPP Rel-16

A Conditional PSCell Change (CPC) procedure was standardized in Rel-16. Therein a UE operating in Multi-Radio Dual Connectivity (MR-DC) receives in a conditional reconfiguration configuration of one or multiple target candidate cells i.e. in one or multiple RRC Reconfiguration(s) (e.g. an RRCReconfiguration* message) containing an SCG configuration (e.g. a secondaryCellGroup of IE CellGroupConfig). Each configuration of a target candidate cell with a reconfigurationWithSync is stored and associated to an execution condition (e.g. a condition like an A3/A5 event). In this context, the asterisk “*” may represent an indicia used to differentiate RRCReconfiguration messages associated with different cells (such that RRCReconfiguration1 is associated with one particular cell, RRCReconfiguration2 is associated with another cell, etc), and/or different combinations of a cell and an execution condition (such that RRCReconfiguration1 is associated with one particular cell and a first execution condition, RRCReconfiguration2 is associated with the same cell with a different execution condition, or a different cell, etc). One of the stored messages (one of the RRCReconfiguration* messages) is applied upon the fulfillment of the execution condition, upon which the UE would perform PSCell change (e.g. in case it finds a neighbour cell that is better than the current SpCell of the SCG, if the configured condition is like the A3 event defined in TS 38.331). Only intra-SN CPC without Master Node (MN) involvement is standardized in 3GPP Rel-16, i.e. for cases where the (candidate) target PSCells are located in the current serving Secondary Node (SN).

### Conditional PSCell Addition (CPA) and Inter-SN CPC in 3GPP Rel-17

In 3GPP Rel-17, Conditional PSCell Addition (CPA) and inter-SN CPC have been introduced. The CPA procedure is used for adding a PSCell/SCG to the configuration for a UE that is currently only configured with a Master Cell Group (MCG), when associated execution conditions are fulfilled. CPA configuration is initiated by the MN by requesting an SCG configuration, which is to be provided as part of a conditional reconfiguration to the UE, from a (candidate) target SN (T-SN), and then sending it in a conditional reconfiguration to the UE together with the associated execution conditions.

The inter-SN CPC can be initiated either by the MN or by the source SN (S-SN), where the signalling towards the source SN and the (candidate) target SNs (T-SNs), as well as towards the UE, in both cases is handled by the MN. One of the possible signalling sequences for configuration of an inter-SN CPC, which is initiated by the source SN, can be seen in the signaling flow in FIG. 2, which illustrates inter-SN CPC in 3GPP Rel-17 involving a UE 202, an MN 204, an S-SN 206, and a T-SN 208. The S-SN 206 serves a PSCell (“Cell A”). The T-SN 208 serves a Cell B and a Cell C.

At step 210, the S-SN 206 sends an SN Change Required message (including Cell B, Cell C, conditions, . . . ) to the MN 204.

At step 212, the MN 204 sends an SN Addition Request (CPC) message to the T-SN 208.

At step 214, the T-SN 208 sends a SN Addition Request Ack message to the MN 204.

At step 216, the MN 204 generates a conditional PSCell change configuration.

At step 218, the MN 204 sends an RRCReconfiguration message to the UE 202.

At step 220, the UE 202 sends an RRCReconfigurationComplete message to the MN 204.

At step 222, the MN 204 sends an SN Change Confirm (accepted candidates) message to the S-SN 206.

Also for Rel-17 Conditional PSCell change (CPC)/Conditional PSCell addition (CPA), it can be expected that the UE configured with CPC/CPA has to release the CPC/CPA configurations when completing random access towards the target PSCell.

### Releasing CPC Related Configurations of Target Candidates Upon Successful Execution

When the UE executes CPC or when the UE executes a handover (while configured with CPC), the UE i) releases the target candidate configurations i.e. releases the stored RRCReconfiguration* messages (as denoted in TS 37.340 v17.1.0), which are stored in a UE variable e.g. VarConditionalReconfig for New Radio (NR) target candiate PSCells; ii) release the CPC related measurement configuration(s) i.e. the measId (and associated reportConfig(s) and measObject(s)) whose condTriggerConfig in the reportConfig is set to condTriggerConfig.

See the following extracts from 3GPP TS 38.311, v17.1.0:

### 5.3.5.13.5 Conditional Reconfiguration Execution

The UE shall:
[ . . . ]
for the selected cell of conditional reconfiguration execution:
2> apply the stored condRRCReconfig of the selected cell and perform the actions as specified in 5.3.5.3;
[ . . . ]

### 5.3.5.3 Reception of an RRCReconfiguration by the UE

The UE shall perform the following actions upon reception of the RRCReconfiguration, or upon execution of the conditional reconfiguration (CHO, CPA or CPC):
[ . . . ]
1> if reconfigurationWithSync was included in spCellConfig of an MCG or SCG, and when MAC of an NR cell group successfully completes a Random Access procedure triggered above:
[ . . . ]
2> if the reconfigurationWithSync was included in spCellConfig of an MCG; or
2> if the reconfigurationWithSync was included in spCellConfig of an SCG and the CPA or CPC was configured
3> remove all the entries within VarConditionalReconfig, if any;
3> remove all the entries within VarConditionalReconfiguration as specified in TS 36.331 [10], clause 5.3.5.9.6, if any;
3> for each measId of the source SpCell configuration, if the associated reportConfig has a reportType set to condTriggerConfig:
4> for the associated reportConfigId:
5> remove the entry with the matching reportConfigId from the reportConfigList within the VarMeasConfig;
4> if the associated measObjectId is only associated to a reportConfig with reportType set to condTriggerConfig:
5> remove the entry with the matching measObjectId from the meas ObjectList within the VarMeasConfig;
4> remove the entry with the matching measId from the measIdList within the VarMeasConfig;
[END]
   NR-DC with Selective Activation of the Cell Groups (at Least for SCG) Via L3 Enhancements in 3GPP Rel-18

For 3GPP Rel-18, work is starting up to introduce enhancements for different mobility procedures, with a Work Item Description in 3GPP RP-213565 (“New WI: Further NR mobility enhancements”, MediaTek). One of the current objectives is “to specify mechanism and procedures of NR-DC with selective activation of the cell groups (at least for SCG) via L3 enhancements”, which includes “to allow subsequent cell group change after changing CG without reconfiguration and re-initiation of CPC/CPA”.

It should thus be possible to perform a subsequent cell group change after a first cell group change, without reconfiguring or re-initiating Conditional PSCell Change (CPC) or Conditional PSCell Addition (CPA). This would then be done in order to reduce the interruption time and the signalling overhead for SCG changes, especially in the case of frequent SCG changes when operating in FR2 in NR, compared to when these configurations are released when the UE completes random access towards the target PSCell, as in the previous releases.

### SUMMARY

There currently exist certain challenge(s).

In the work for 3GPP Rel-18 a UE shall be able to store conditional reconfigurations, e.g. for Conditional PSCell Change (CPC), when moving between different serving cells, e.g. PSCells. In other words, the UE shall not delete, discard or release the stored CPC related configurations: such as the CPC related MeasConfig (e.g. measId(s), measObject(s) and ReportConfig(s) associated to the execution condition(s)) and the RRC Reconfiguration per target candidate PSCell (RRCReconfiguration* per candidate PSCell). It will thereby be possible for a UE to move between e.g. different PSCells (for the SCG) without the need to reconfigure the UE with CPC for the same PSCell target candidates which are already configured at the UE (or configure it with non-conditional PSCell changes). This is expected to result in considerable efficiency savings, in terms of signalling overhead and better use of radio resources.

However, even if the UE does not release the stored CPC related configuration upon a PSCell change, it is not clear what happens to the current serving cell the UE is leaving (i.e. the source PSCell). It is likely that the serving cell the UE is leaving could be a good candidate PSCell after CPC execution or PSCell execution. With the current Rel-18 assumptions, an RRC reconfiguration would be required to add that previous cell when a Primary Cell (PCell) change happens, which defeats the purpose of the feature introduced in Rel-18, e.g., to avoid the need to have a reconfiguration after every CPC or PSCell execution. For example, a CPC configuration for the current serving PSCell (i.e. with the current PSCell as target cell) would be useful when the UE moves to another PSCell, where such CPC configuration then would be available for a subsequent/later conditional PSCell to the current PSCell.

However, no procedure for configuring the UE with a CPC configuration for the current serving PSCell currently exists. To configure the UE with a CPC configuration with the current PSCell as target cell and with e.g. condEventA3 (conditional event A3) as execution condition, i.e. that “Neighbour becomes offset better than SpCell”, would be ambiguous. The same is applicable for CHO for the current serving PCell.

There is then no support specified for configuring a UE with e.g. a CPC configuration where the current PSCell is the target candidate cell. It is thus not clear how a UE can be configured with a conditional configuration, e.g., CPC or CPA for the serving PSCell or e.g. CHO for the serving PCell, so that it then can be used as CPC or CHO configuration when the UE moves to another cell PSCell or PCell, respectively.

Certain aspects of the disclosure and their embodiments may provide solutions to these or other challenges.

### UE Actions

The disclosure includes methods to configure a UE with a conditional reconfiguration, e.g. a Conditional PSCell Change (CPC) configuration, where the target candidate cell in the configuration is the same as the current serving cell, e.g. the current serving PSCell.

The method may comprise the UE executing a PSCell change (e.g. due to a CPC execution or a PSCell change triggered by the network) from a source PSCell (e.g. cell A) to a target PSCell (e.g. cell B), and considering the source PSCell (e.g. cell A) as a target candidate for CPC when it operates in the target cell i.e. after the PSCell change. The method may further comprise one of more of:
storing the configuration of the source PSCell (e.g. storing RRCReconfiguration* for cell A) as the configuration of a target candidate configuration for CPC;
associating the stored configuration of the source PSCell to an execution condition;
monitoring the associated execution condition.

The method may further comprise, while the UE is in the target PScell (e.g. cell B)), determining that the execution condition associated to the source PSCell (e.g. cell A) is fulfilled, and selects the previous source PSCell (cell A) as a target candidate PSCell; then, applies the stored configuration of the previous source PSCell (e.g. UE applies the RRCReconfiguration* for cell A).

The method may further comprise the UE determining whether to consider or not the source PSCell (e.g. cell A) as a target candidate PSCell when PSCell change is performed to a PSCell (e.g. cell B).

For example, the method may further comprise determining based on an indication, wherein the indication may be one or more of:
a signaling received from the network (e.g. RRC filed, Information Element (IE)) indicating that the UE shall consider the current PSCell as a target PSCell candidate if the UE performs a PSCell change and/or;
a signaling received from the network (e.g. RRC filed, IE) indicating that the UE shall consider the current PSCell as a target PSCell candidate if the UE performs a PSCell change to one or more PSCell(s) e.g. cell B, otherwise the UE does not consider the current PSCell as a target PSCell candidate; in other word, the indication may be per target candidate cell;

For example, the method may further comprise the UE performing one or more of:
i. storing the configuration of the source PSCell (e.g. storing RRCReconfiguration* for cell A) as the configuration of a target candidate configuration for CPC, and determining whether that is to be considered as a target candidate after PSCell change to a first target (candidate) PSCell (e.g. cell B), and:
   a. if YES, monitoring the associated execution condition;
   b. Else, if NO, do not monitor the associated execution condition; and:
      i. upon a subsequent PSCell change to a second target (candidate) PSCell (e.g. from the first target PSCell, cell B, to a cell C), determining whether the previous source PSCell (e.g. cell A) is to be considered as a target candidate cell after PSCell change to the second target (candidate) PSCell (e.g. cell C).
ii. determining whether the source PSCell (e.g. cell A) is to be considered as a target candidate after PSCell change to a first target (candidate) PSCell (e.g. cell B), is based on a signaling received from the network.

### Network Actions

The method comprises the network (e.g., a network node such as a Radio Access Network (RAN) node) configuring the UE to perform one or more actions when the UE executes a PSCell change (e.g. due to a CPC execution or a PSCell change triggered by the network) from a source PSCell (e.g. cell A) to a target PSCell (e.g. cell B), wherein the one or more actions comprise the UE considering the source PSCell (e.g. cell A) as a target candidate for CPC when it operates in the target cell i.e. after the PSCell change. The method may further comprise one of more of:
storing the configuration of the source PSCell (e.g. storing RRCReconfiguration* for cell A) as the configuration of a target candidate configuration for CPC e.g. in the UE context;
associating the stored configuration of the source PSCell to an execution condition.

Methods on interaction between the network and the UE to prepare mobility with the stored conditional configurations are also disclosed.

One core embodiment is that the UE executes a PSCell change (e.g. CPC execution) from a source cell A to target cell B, and stores the configuration of cell A (e.g., RRCReconfiguration* for cell A) as a target candidate configuration for CPC when it is at least in cell B.

Certain embodiments may provide one or more technical advantage(s).

One advantage is that for a UE configured with CPC target candidate cells (e.g. B, C, D), after a PCell change (e.g. CPC execution or network-triggered PSCell change from source PSCell A to PScell C), the source PSCell the UE is leaving is considered as a target candidate cell after the PSCell execution. In other words, when the UE is in cell C, cell A is a target candidate PScell for CPC and the UE will have a stored configuration for cell A. Thanks to that, there is no need to an additional reconfiguration after a PScell change to add that source PSCell as a candidate.

Another advantage of the solution is to provide ways to indicate to the UE whether to store the conditional reconfiguration(s) before a cell group change procedure, wherein that conditional reconfiguration is for the source PSCell/current PSCell. This would help both the UE and the network save signaling when sending the configuration.

### BRIEF DESCRIPTION OF THE DRAWINGS

For a better understanding of the embodiments of the present disclosure, and to show how it may be put into effect, reference will now be made, by way of example only, to the accompanying drawings, in which:

FIG. 1 shows a signalling and processing flow for conditional handover execution;

FIG. 2 shows inter-SN CPC in 3GPP Rel-17;

FIG. 3 shows a system according to embodiments of the disclosure;

FIG. 4 is a flowchart of a method in a user equipment according to embodiments of the disclosure;

FIG. 5 is a flowchart of a method in a network node according to embodiments of the disclosure;

FIG. 6 is a signalling and/or processing flow conditional configuration according to embodiments of the disclosure;

FIG. 7 is a flowchart of a further method in a user equipment according to embodiments of the disclosure;

FIG. 8 shows an example of a communication system in accordance with some embodiments;

FIG. 9 shows a UE in accordance with some embodiments;

FIG. 10 shows a network node in accordance with some embodiments;

FIG. 11 is a block diagram of a host in accordance with various aspects described herein;

FIG. 12 is a block diagram illustrating a virtualization environment in which functions implemented by some embodiments may be virtualized; and

FIG. 13 is a block diagram showing a communication diagram of a host communicating via a network node with a UE over a partially wireless connection in accordance with some embodiments.

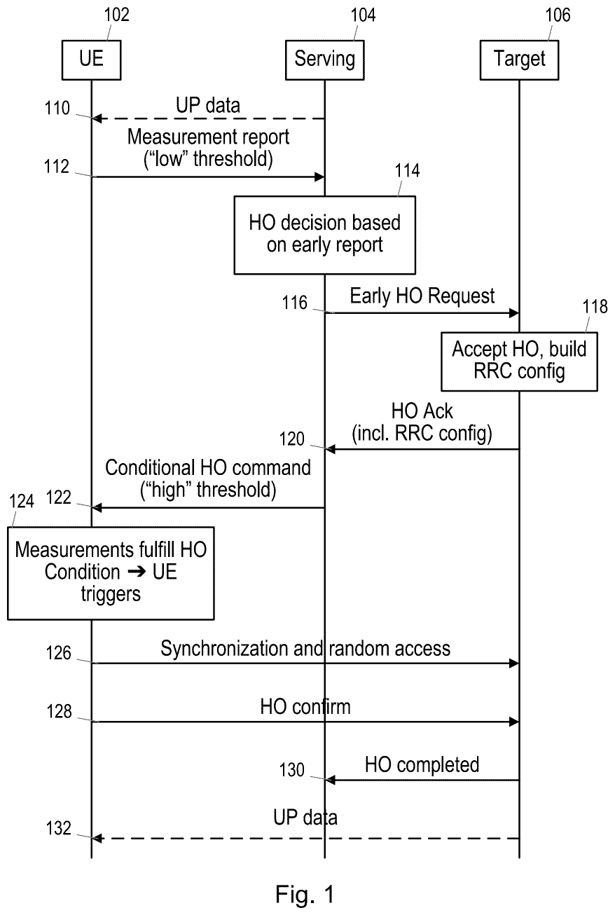

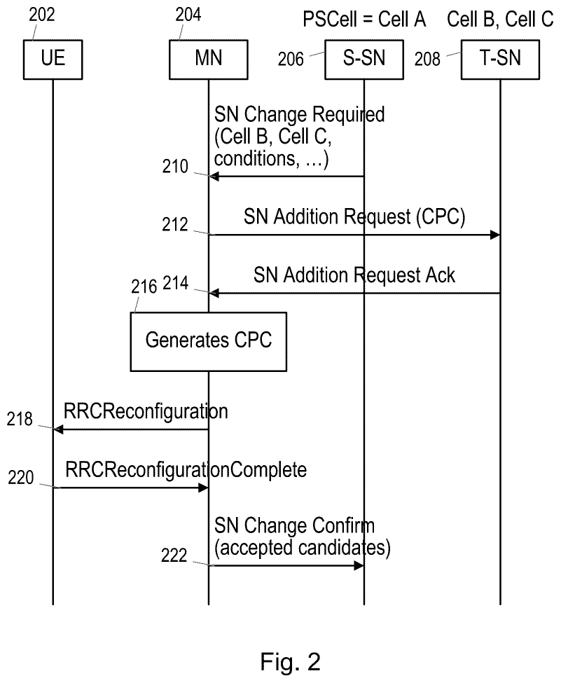

### DETAILED DESCRIPTION

Some of the embodiments contemplated herein will now be described more fully with reference to the accompanying drawings. Embodiments are provided by way of example to convey the scope of the subject matter to those skilled in the art.

### Initial Disclaimers

The disclosure may refer to a first network node operating as a Master Node (MN), e.g. having a Master Cell Group (MCG) configured to the UE; that MN can be a gNodeB, or a Central Unit gNodeB (CU-gNB) or an eNodeB, or a Central Unit eNodeB (CU-eNB), or any network node and/or network function. The disclosure also refers to a second network node operating as a Secondary Node (SN), or Source Secondary Node (S-SN) e.g. having a Secondary Cell Group (SCG) pre-configured (i.e. not connected to) to the UE; that SN can be a gNodeB, or a Central Unit gNodeB (CU-gNB) or an eNodeB, or a Central Unit eNodeB (CU-eNB), or any network node and/or network function. Notice that MN, S-SN and T-SN may be from the same or different Radio Access Technologies (and possibly be associated to different Core Network nodes).

The text often refers to a “Secondary Node (SN)”, or target SN. This is equivalent to say this is a target candidate SN, or a network node associated to a target candidate PSCell that is being configured. If the UE would connect to that cell, transmissions and receptions with the UE would be handled by that node if the cell is associated to that node.

The text may state that a cell resides in a node e.g. a target candidate cell resides in the S-SN or the T-SN. That is equivalent to say that a cell is managed by the node, or is associated to the node, or associated with the node, or that the cell belongs to the node, or that the cell is of the node.

“SN-initiated CPC” corresponds to a procedure wherein the Source SN for a UE configured with MR-DC determines to configure CPC. Upon determining the Source SN selects e.g. based on reported measurements, one or more target candidate cells (target candidate PSCell(s)) wherein at least one cell is associated to the Source SN, and at least another cell is associated to a neighbour SN. It can be said that if all target candidate cells are associated to the Source SN that is an “SN-initiated intra-SN CPC”, which may be referred as the Release 16 solution. It can be said that if at least one target candidate cell is associated to a neighbour SN that is an “SN-initiated inter-SN CPC”, which may be referred as a Release 17 solution.

The text may refer to a candidate SN, or SN candidate, or an SN, as the network node (e.g. gNodeB) that is prepared during the CPA procedure and that can create an RRC Reconfiguration message with an SCG configuration (e.g. RRCReconfiguration**) to be provided to the UE and stored, with an execution condition, wherein the UE only applies the message upon the fulfillment of the execution condition. That candidate SN is associated to one or multiple PSCell candidate cell(s) that the UE can be configured with. The UE then can execute the condition and accesses one of these candidate cells, associated to a candidate SN that becomes the SN or simply the SN after execution (i.e. upon fulfillment of the execution condition).

The text may refer to a Conditional PSCell Change (CPC) configuration and procedures (like CPC execution), most of the time to refer to the procedure from the UE perspective. Other terms may be considered as synonyms such as conditional reconfiguration, or Conditional Configuration (since the message that is stored and applied upon fulfillment of a condition is an RRCReconfiguration or RRCConnectionReconfiguration). Terminology wise, one could also interpret conditional handover (CHO) in a broader sense, also covering CPA (Conditional PSCell Change) procedures. The document refers to a Conditional SN Change most of the time to refer to the procedure from the UE perspective, to refer to procedures between network nodes wherein a node requests a target candidate SN (which may be the same as the Source SN or a neighbour SN) to configure a conditional PSCell Change (CPC) for at least one of its associated cells (cell associated to the target candidate SN).

The text may refer to CPAC as a way to refer to either a Conditional PSCell Addition (CPA) or a Conditional PSCell Change (CPC).

The text may refer to a neighbour SN and a Source SN as different entities, though both could be a target candidate SN for CPC.

The configuration of CPC can be done using the same IEs as conditional handover, which may be called at some point conditional configuration or conditional reconfiguration. The principle for the configuration is the same with configuring triggering/execution condition(s) and a reconfiguration message to be applied when the triggering condition(s) are fulfilled. The configuration IEs from TS 38.331, v17.1.0:

### ConditionalReconfiguration

The IE ConditionalReconfiguration is used to add, modify and release the configuration of conditional configuration.

### ConditionalReconfiguration Information Element

-- ASN1START
-- TAG-CONDITIONALRECONFIGURATION-START

| ConditionalReconfiguration-r16 ::= | SEQUENCE { | |
|---|---|---|
| attemptCcondReconfig-r16 | ENUMERATED {true} | OPTIONAL, - |

- Need N

| | | |
|---|---|---|
| condConfigToRemoveList-r16 | CondConfigToRemoveList-r16 | OPTIONAL, -- |

Need N

| | | |
|---|---|---|
| condConfigToAddModList-r16 | CondConfigToAddModList-r16 | OPTIONAL, -- |

Need N
...
}

| | |
|---|---|
| CondConfigToRemoveList-r16 ::= | SEQUENCE (SIZE (1.. maxNrofCondCells)) OF |

CondConfigId-r16
-- TAG-CONDITIONALRECONFIGURATION-STOP
-- ASN1STOP

ConditionalReconfiguration field descriptions

condConfigToAddModList
List of the configuration of candidate SpCells to be added or modified for
CHO or CPC.
condConfigToRemoveList
List of the configuration of candidate SpCells to be removed. When the
network removes the stored conditional configuration for a candidate cell,
the network releases the measIDs associated to the condExecutionCond if
it is not used by the condExecutionCond of other candidate cells.

### CondConfigId

The IE CondConfigId is used to identify a CHO or CPC configuration.

### CondConfigId Information Element

| -- ASN1START | |
|---|---|
| -- TAG-CONDCONFIGID-START | |
| CondConfigId-r16 ::= | INTEGER (1.. maxNrofCond-Cells) |

-- TAG-CONDCONFIGID-STOP
-- ASN1STOP

### CondConfigToAddModList

The IE CHO-ConfigToAddModList concerns a list of conditional configurations to add or modify, with for each entry the cho-ConfigId and the associated condExecutionCond and condRRCReconfig.

### CondConfigToAddModList Information Element

-- ASN1START
-- TAG-CONDCONFIGTOADDMODLIST-START

| | |
|---|---|
| CondConfigToAddModList-r16 ::= | SEQUENCE (SIZE (1.. maxNrofCondCells)) |

OF CondConfigToAddMod-r16

| | |
|---|---|
| CondConfigToAddMod-r16 ::= | SEQUENCE { |
| condConfigId-r16 | CondConfigId-r16, |
| condExecutionCond-r16 | SEQUENCE (SIZE (1..2)) OF MeasId |

OPTIONAL, -- Need S

| | |
|---|---|
| condRRCReconfig-r16 | OCTET STRING (CONTAINING |

RRCReconfiguration) OPTIONAL, -- Need S
...
}
-- TAG-CONDCONFIGTOADDMODLIST-STOP
-- ASN1STOP

CondConfigToAddMod field descriptions

condExecutionCond
The execution condition that needs to be fulfilled in order to trigger the
execution of a conditional configuration. The field is mandatory present
when a condConfigId is being added. Otherwise, when the
condRRCReconfig associated to a condConfigId is being modified it is
optionally present and the UE uses the stored value if the field is absent.
condRRCReconfig
The RRCReconfiguration message to be applied when the condition(s) are
fulfilled. The field is mandatory present when a condConfigId is being
added. Otherwise, when the condExecutionCond associated to a
condConfigId is being modified it is optionally present and the UE uses
the stored value if the field is absent.

In the different embodiments of the disclosure these IEs are used differently e.g. sometimes generated by the MN, sometimes generated by the source SN, sometimes by a target candidate SN.

In the different embodiments of the disclosure it is said the CPC is in MN format when the CPC configuration is not configured as an MR-DC configuration in mrdc-SecondaryCellGroup (as defined in TS 38.331). In other words, the UE receives an RRCReconfiguration from the MN that may contain the mrdc-Secondary CellGroup (e.g. in case the UE is also configured with an SCG MeasConfig for inter-SN CPC) but the CPC is not within that container. That means the IEs listed above (e.g. the IE ConditionalReconfiguration) are not included in mrdc-Secondary CellGroup.

In the different embodiments of the disclosure it is said the CPC is in SN format when the CPC configuration is configured as an MR-DC configuration in mrdc-SecondaryCellGroup (as defined in TS 38.331). In other words, the UE receives an RRCReconfiguration from the MN that may contain the mrdc-Secondary CellGroup and the CPC is within that container. That means the IEs listed above (e.g. the IE ConditionalReconfiguration) are included in mrdc-SecondaryCellGroup (e.g. within a series of other nested IEs).

The document refers to that the UE stores or releases/discards a conditional reconfiguration at execution of a mobility procedure. The mobility procedure that is executed may correspond to (but is not restricted to) a conditional reconfiguration, e.g. a Conditional Handover (CHO), a Conditional PSCell Change (CPC) or a Conditional PSCell Addition (CPA) procedure, or a corresponding non-conditional mobility procedure, e.g. a handover, PSCell change or PSCell addition. It may also correspond to another type of reconfiguration, such as e.g. addition, modification or release of a cell group, of a cell or of another configuration. The mobility procedure that is executed may however also correspond to a change of state for a part of the UE configuration, e.g. a change of state for the Secondary Cell Group (SCG) where the SCG state is changed from deactivated to activated or from activated to deactivated, or a change of state for one or more Secondary Cells (SCell(s)). The execution of the mobility procedure may include that the UE performs a reconfiguration with sync procedure (with or without performing a random access procedure towards the (target) cell) or that the UE does not perform a reconfiguration with sync.

In some embodiments the document refers to the current serving cell and/or the source cell as the same cell the UE is connected to, or being served by, when a mobility procedure is triggered so that the UE leaves the current serving cell i.e. leaves the source cell, to a target cell, which will became after the mobility procedure the new serving cell.

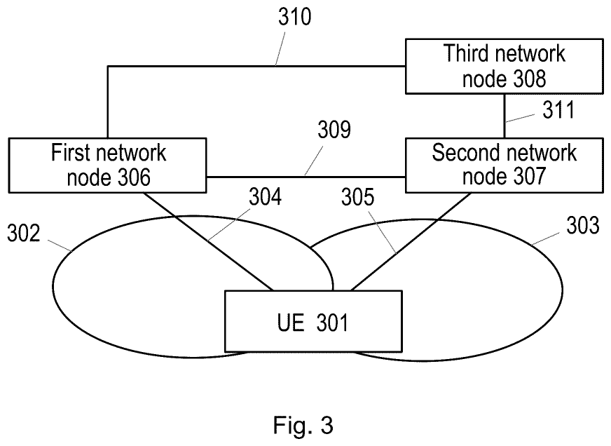

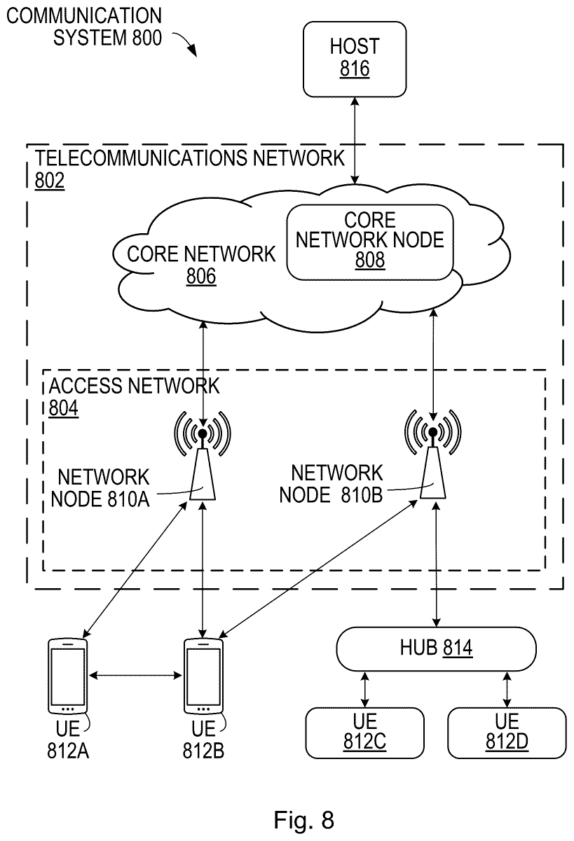

FIG. 3 is an overview of a system structure according to embodiments of the disclosure and illustrates the main entities in a system according to embodiments of the disclosure. See also the wireless network described below with respect to FIG. 8 for further information. The User Equipment (UE) 301 is a wireless terminal, such as a cellular smartphone. The UE 301 is sometimes configured for multi-radio dual connectivity (MR-DC).

The UE 301 is connected via a first cell group 302 to a first network node 306 over a radio interface 304. When the UE 301 is configured in MR-DC, the UE 301 is also connected via a second cell group 303 to a second network node 307 over a radio interface 305.

The first network node 306, sometimes known as a Master Node (MN), controls the first cell group 302, sometimes known as the Master Cell Group (MCG). The first cell group 302 is configured with a main cell, such as a Primary Cell (PCell) and optionally multiple additional cells, such as Secondary Cells (SCells), in a Carrier Aggregation (CA) configuration.

When the UE 301 is configured in MR-DC, the second network node 307, sometimes known as a Secondary Node (SN) controls the second cell group 303, sometimes also known as the Secondary Cell Group (SCG). The second cell group 303 is configured with a main cell, such as a Primary SCG Cell (PSCell) and optionally multiple additional cells, such as secondary cells (SCells) in a CA configuration. The second network node 307 is connected with the first network node 306 over an interface 309.

The third network node 308, is in the context of a mobility procedure or a conditional configuration sometimes also referred to as a target Secondary Node (T-SN), a target MN (T-MN), a target gNB or a target eNB. It controls a third cell group (not illustrated in the figure), including a cell during a mobility procedure in the context of a mobility procedure or a conditional configuration sometimes referred to as a candidate target cell or a target cell. The third network node 308 is connected to the first network node 306 over an interface 310 and may also be connected to the second network node 307 over an interface 311.

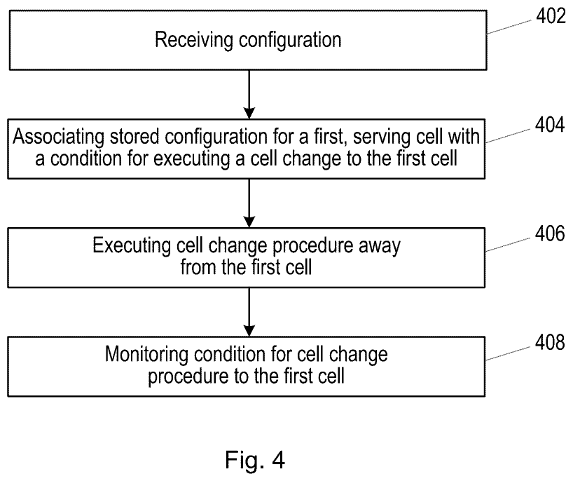

FIG. 4 depicts a method in accordance with particular embodiments. The method 4 may be performed by a UE or wireless device (e.g. the UE 301, UE 812 or UE 900 as described with reference to FIGS. 3, 8 and 9 respectively). The UE may initially be served by a first cell. The first cell may be a PCell or a PSCell, for example.

The method begins at step 402, in which—optionally—the UE receives a configuration from a communication network. The configuration may be received from a serving network node for the UE, for example. The configuration may be received in an RRC configuration message, or in a broadcast message such as system information. The configuration may configure the UE to perform one or more of the actions below.

The UE may be configured as set out herein responsive to a determination that the UE is capable of performing one or more actions as described below. That is, on connection to the communication network, the UE may report its capabilities to the network. The capabilities may include an indication that the UE is capable of performing conditional cell change procedures (such as CPA or CPC, defined above), and/or that the UE is capable of storing a conditional cell reconfiguration towards a current serving cell.

For example, the UE may transmit to the network at least one capability information indicating to the network that the UE is capable of receiving a conditional reconfiguration including a target candidate cell which is the same as the current serving cell. Then, the network configures the UE with conditional configurations, where one of the target candidates is the current serving cell (e.g. UE's PSCell) is based on the received UE capability information.

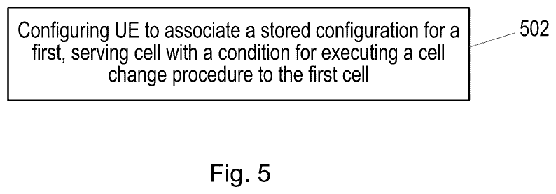

For more detail on the configuration of the UE, see the method described with respect to FIG. 5. In alternative or additional embodiments, the UE may be pre-programmed (e.g., in accordance with one or more wireless communication standards) to perform one or more of the actions set out below.

In step 404, the UE associates a stored configuration for the first, serving cell with a condition for executing a cell change procedure to the first cell. For example, the stored configuration may comprise a RRC reconfiguration message for the first cell (e.g., RRCReconfiguration* message). Performance of step 404 may be responsive and/or subject to the configuration received in step 402.

Thus the UE stores a conditional reconfiguration associated with its currently serving cell (i.e., the first cell). The conditional reconfiguration comprises a configuration (e.g., an RRC configuration) to be applied upon executing a cell change procedure to the first cell, and a corresponding condition, upon fulfilment of which, the UE executes the cell change procedure to the first cell. The conditional reconfiguration may correspond to a Conditional PSCell Change (CPC) configuration with the target PSCell (also called a target candidate PSCell) being the same as the current serving PSCell, i.e., the first cell (which may be called source PSCell). In another set of embodiments, the conditional reconfiguration may correspond to a Conditional Handover (CHO) configuration with the target PCell (also called a target candidate PCell) being the same as the current serving PCell, i.e., the first cell. In a further embodiment, the conditional reconfiguration may correspond to conditional PSCell addition (CPA), with the new PSCell corresponding to the first cell.

The condition for executing the cell change procedure may be associated with one or more radio measurements (e.g., reference signal received power, reference signal received quality, Signal-to-Noise Ration (SNR), etc) performed on transmissions by the first cell and one or more neighbouring cells. For example, the condition may comprise one or more thresholds applied to radio measurements of the first cell, radio measurements of the neighbour cell(s) and/or a difference between radio measurements of the first cell and the neighbour cell(s) (e.g., Reference Signal Received Power (RSRP) for the first cell is X dB greater than RSRP for the neighbour cell, etc). Note that, in this context, one of the neighbouring cells may have become a serving cell by the time that the condition is monitored and/or the cell change procedure to the first cell is executed. The one or more radio measurements may be specified in a measurement configuration that is associated with the first cell and/or the second cell (and/or the stored configuration).

The stored configuration may be associated with more than one condition. For example, the stored configuration may be associated with a first condition, which is associated with changing from a second cell (e.g., a particular cell) to the first cell, and a second condition, which is associated with changing from a third cell to the first cell. That is, the UE may apply different conditions for changing to the first cell depending on the cell that becomes its serving cell. In one embodiment, the stored configuration is associated with a plurality of conditions, with each condition being associated with a cell change procedure from a respective cell to the first cell.

Prior to executing the cell change procedure away from the first cell, the UE may refrain from monitoring the condition. In this option, therefore, upon reception and/or storing of the conditional reconfiguration, the UE monitors the execution condition associated to a target candidate cell only if the target candidate cell is a cell which is not the current serving cell. For example, the UE monitors the execution condition associated to a target candidate cell only if the cell identifier (e.g. Physical Cell Identity (PCI)) of the target candidate cell is not the same as the cell identifier (e.g. PCI) of the current serving cell AND the frequency (e.g. Synchronization Signal Block (SSB) frequency) of the target candidate cell is not the same as the frequency (e.g. SSB frequency) of the current serving cell.

Alternatively or additionally, upon reception and/or storing of the conditional reconfiguration, the UE considers a candidate cell an applicable cell i.e. a valid candidate to be monitored, only if the target candidate cell is a cell which is not the current serving cell. For example, the UE considers a candidate cell as an applicable cell only if the cell identifier (e.g. PCI) of the target candidate cell is not the same as the cell identifier (e.g. PCI) of the current serving cell AND the frequency (e.g. Synchronization Signal Block (SSB) frequency) of the target candidate cell is not the same as the frequency (e.g. SSB frequency) of the current serving cell.

In another embodiment, prior to executing the cell change procedure away from the first cell, refraining from executing or triggering the cell change procedure to the first cell. In this case, the condition for executing the cell change procedure to the first cell may be monitored by the UE.

For example, the UE may perform evaluation of the execution conditions associated to the conditional reconfiguration even if the included target cell is the same as the current serving cell, but it does then not trigger any execution of the included configuration even if the execution conditions are fulfilled. If the conditional reconfiguration is then kept when the UE moves to another cell, i.e. where the target cell included in the conditional reconfiguration is no longer the same as the current serving cell, the UE will then (in that other serving cell) perform evaluation of, and can then also trigger execution of, the conditional reconfiguration.

In one alternative where the UE is configured with a conditional reconfiguration where the included target candidate cell is the same as the current serving cell, the UE also checks the conditional event(s) that is/are associated to (the execution conditions for) the conditional reconfiguration so that the evaluation and/or triggering of the execution of the conditional reconfiguration is only skipped for some types of conditional events. In one example, the UE then skips evaluation of and/or triggering execution of the conditional reconfiguration if the conditional event is any of a CondEvent A3 (or event A3), i.e. that “Neighbour becomes offset better than SpCell” or a CondEvent A5 (or event A5), i.e. that “SpCell becomes worse than threshold1 and neighbour becomes better than threshold2”. In these cases the execution conditions for the conditional reconfiguration are related to that a neighbour cell (the candidate target cell in case of a conditional reconfiguration) becomes better than the serving cell (i.e. the SpCell). In one example, the UE skips evaluation of and/or triggering execution of the conditional reconfiguration (where the included target cell is the same as the current serving cell) if the conditional event is a CondEvent A4 (or event A4), i.e. that “Neighbour becomes better than threshold”.

Any one or more of these actions may be subject or responsive to the configuration received in step 402. For example, the UE may receive an indication from the network whether to skip evaluation and/or triggering of the execution of the conditional reconfiguration in case the target cell for the conditional reconfiguration is the same as the current serving cell. In one example, if the network has set the indication and the target cell that is included in the conditional reconfiguration is the same as the current serving cell, the UE skips evaluation of and/or triggering execution of the conditional reconfiguration. If the network has not set the indication, the UE then however performs evaluation of, and can also trigger execution of, the conditional reconfiguration even if the included target cell is the same as the current serving cell. In one example, the indication from the network can be included within, or together with, conditional reconfiguration so that the indication is valid for a specific conditional reconfiguration. In one other example, the indication from the network is valid for several conditional reconfigurations, such as for all the conditional reconfigurations that the UE is configured with or for all conditional reconfigurations of a certain type.

In step 406, the UE performs a cell change procedure away from the first cell.

As noted above, the cell change procedure away from the first cell may be a conditional reconfiguration, e.g., a cell change procedure performed subject to fulfilment of a condition that is monitored by the UE. In one example, the cell change procedure comprises a cell change from the first cell to a second cell. That is, the UE moves from the first cell to the second cell. Such a change may comprise a handover (e.g., a conditional handover) from one PCell to another PCell; or a PSCell change (e.g., a CPC) from one PSCell to another PSCell. In another embodiment, the cell change procedure away from the first cell may comprise release of the first cell. For example, the first cell may comprise a PSCell of a secondary cell group (SCG). The UE may move away from the first cell by releasing the SCG, e.g., releasing dual connectivity. In this case, the cell change procedure to the first cell may correspond to conditional PSCell addition (CPA), e.g., the addition of an SCG.

In one embodiment, the cell change procedure from the first cell to the second cell is therefore a conditional reconfiguration. In such embodiments, the UE may continue to store the conditional reconfiguration to the second cell, e.g., the RRCReconfiguration* message associated with the second cell. In this way, the UE is already configured with the stored configuration for the cell change procedure to the second cell (which has become the serving cell). The UE may transmit an indication or a confirmation message to a network node serving the second cell to confirm that it has stored the configuration for the cell change procedure and this does not require further configuration from the network. Such an indication or confirmation message may be transmitted in response to a query message from the network node serving the second cell.

In step 408, the UE monitors the condition for the cell change procedure to the first cell. Performance of step 408 may be responsive to the configuration received in step 402.

Upon fulfilment of the condition, the UE may execute the cell change procedure to the first cell.

In additional embodiments, the UE may release the stored configuration and associated condition responsive to a determination that the user equipment is greater than a threshold distance from a reference location associated with the first cell.

In one set of embodiments the UE is instructed (e.g. by receiving an indication from the network) to keep or release a conditional reconfiguration for the current serving PSCell e.g. when there is a change of serving cell.

In one embodiment, the UE is configured with a conditional reconfiguration including the current PSCell as a target candidate cell i.e. including an RRCReconfiguration* whose at least one target candidate cell is the current PSCell. That means that the UE receives a configuration for the current PSCell, conditional configurations for other target candidate PSCells and also a CPC configuration for the current PSCell. The CPC configuration for the current PSCell comprises execution conditions for CPC and a configuration to apply when the conditions are fulfilled (denoted RRCReconfiguration*).

In one option, the configuration to be applied may be an indication indicating that the UE may use the current PSCell configuration as configuration that is applied when the conditions are fulfilled.

In one option, the UE only receives the conditions and the configuration to be applied when the UE returns to the current PSCell is the current PSCell configuration.

The conditions may initially be “deactivated” as long as the UE remains in the current/first PSCell. When the UE has changed PSCell to a second PSCell, the conditions for returning to the first PSCell may become “activated”.

In one example the UE keeps the conditional configuration for the serving PSCell, i.e., before execution of a mobility procedure, based on a defined timer. This timer could be start from when the UE receives the other conditional reconfiguration(s) from the network via a for example RRC Reconfiguration message. When the timer expires, the UE chooses to release the stored conditional configuration(s).

In another example, the UE determines whether to release the conditional reconfiguration for the serving PSCell based on the distance between UE and a configured reference location is larger or shorter than a configured threshold. For example, if the distance becomes larger than a threshold, the conditional reconfiguration for the serving PSCell is released.

In another example, the UE decides to keep the conditional configuration based on the network's instruction, e.g., an indication within an RRC Reconfiguration message, before execution of a mobility procedure. The indication may e.g. be an indication per conditional reconfiguration, e.g. a bit indicating “save” or a list of the conditional reconfiguration identities, condReconfigId, to be saved. The existing addMod and release-lists for conditional reconfigurations may also be reused, where the absence of the condRRCReconfig (comprising the target configuration to be applied) indicates that the conditional reconfiguration should be maintained and where the release list is used to indicate that the conditional reconfiguration should not be maintained.

In another example, the UE decides to keep certain number of the conditional configurations for the previous serving cells as well based on its own implementation. In this example, the UE indicates to the network which conditional reconfigurations it has saved, e.g. by transmitting the condReconfigId(s) of the stored reconfigurations.

In another example, the UE decides to keep one or more conditional configurations based on the target candidate cell which is being executed. For example, if the UE is in a PCell 3, and has stored the target candidate configurations for cells 1, 2 and 5 e.g. RRCReconfiguration (1), RRCReconfiguration (2), RRCReconfiguration (5). The UE has a mapping indicating that which target candidate configuration to store depending on which target candidate has been selected for CPC execution. One example of the mapping is the following:
If UE selects cell 1→store RRCReconfiguration (2), RRCReconfiguration (5).
If UE selects cell 2→store RRCReconfiguration (3), RRCReconfiguration (5).
. . .
If UE selects cell 5→store all.
If UE selects cell 3→do not store any.

In another example, the UE may store all target candidate configurations upon CPC execution, but it may determine a subset of target candidate cells which are applicable i.e. which may be selected if conditions are fulfilled (or which are monitored for the fulfillment of the execution conditions).

For example, if the UE is in a PCell 3, and has stored the target candidate configurations for cells 1, 2 and 5 e.g. RRCReconfiguration (1), RRCReconfiguration (2), RRCReconfiguration (5). The UE has a mapping indicating that which target candidate configuration to store depending on which target candidate has been selected for CPC execution. One example of the mapping is the following:

In another embodiment, after the UE has executed conditional reconfiguration during a mobility procedure, the UE receives a signaling to query whether it has stored the old conditional configuration from the source cell(s), i.e., the previous serving PSCell.

In one example the UE replies that it has stored the old conditional configuration for the source cell within a RRC message, e.g., RRCReconfigurationComplete message.

In another example, the UE replies that it has no conditional configuration for the source cell within a RRC message, which implies that the network may need to resend the conditional reconfiguration.

In another embodiment, after the UE has executed conditional reconfiguration during a mobility procedure, the UE receives a signaling from the network with the list of possible candidate PSCells for another conditional reconfiguration.

In one example the UE compares a list of the cells provided by network node with its stored conditional configuration(s), decides to inform the network in a RRC message which conditional reconfiguration(s) the UE has stored based on their availability.

In another embodiment, after the UE has executed the conditional reconfiguration to the target cell (e.g. after executing CPC towards a PSCell), the UE stores (e.g. in a UE variable) the conditional reconfiguration, which has been applied, for the cell that became the new serving cell. In one example the UE indicates to the network that the conditional reconfiguration has been stored, e.g. in the RRC Reconfiguration Complete message.

In another embodiment, before the UE applies the conditional reconfiguration to the candidate target cell, the UE stores (e.g. in a UE variable) the conditional reconfiguration in the source PSCell. In one example the UE indicates to the network that the conditional reconfiguration has been stored, e.g. in the RRCReconfiguration* message.

Thus the disclosure includes different methods for a UE to determine whether to keep or release a stored conditional configuration, at execution of a mobility procedure (e.g. after a successful random access procedure to a target SpCell).

In one set of embodiments, the UE is configured by the network with a conditional reconfiguration including at least a target candidate cell of the conditional reconfiguration (for which the UE receives a target candidate configuration denoted RRCReconfiguration* and/or an associated execution conditions and/or a measurement configuration associated to the execution condition) which is the same as the current serving cell. In one example, being “the same as the current serving cell” comprises the cell identifier in the received target candidate configuration, denoted RRCReconfiguration*, (Physical Cell Identity (PCI) in the Reconfiguration with Sync IE, nested in the IE ServingCellConfigCommon) has the same value as the current serving cell's PCI. Upon reception, the UE stores the target candidate configuration (denoted RRCReconfiguration*) but does not perform the evaluation of the associated execution condition and/or does not perform measurements associated to the execution condition (at least as long as the target candidate cell is the current serving cell).

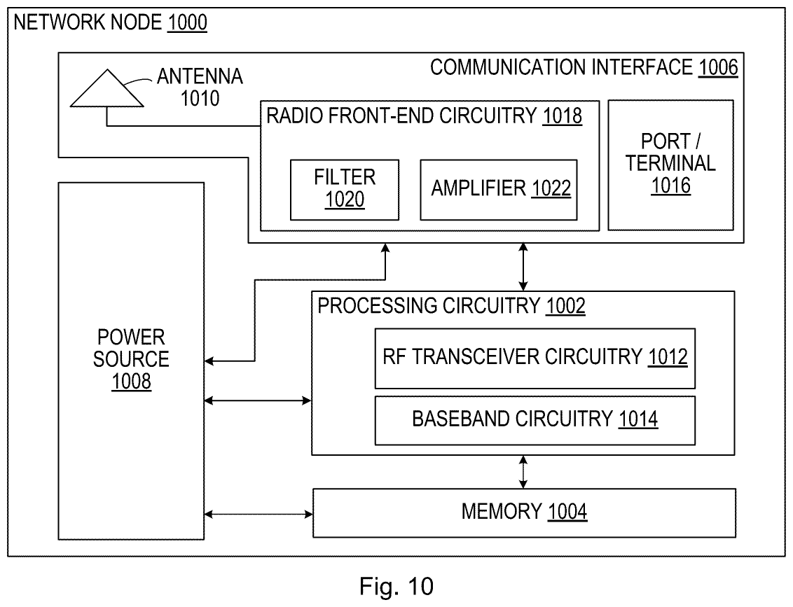

FIG. 5 depicts a method in accordance with particular embodiments. The method 5 may be performed by a network node (e.g. the first network node 306, the second network node 307 or the third network node 308 described with respect to FIG. 3, and/or the network node 810 or network node 1000 as described with reference to FIGS. 8 and 10 respectively). The network node may be a serving network node for a first cell, to which a UE is connected. Alternatively or additionally, the network node may be a master network node (MN) serving the UE, regardless of whether the network node serves the first cell or a different serving cell of the UE.

The method begins at step 502, in which the network node configures the UE to associate a stored configuration for the first, serving cell with a condition for executing a cell change procedure to the first cell. The configuration may be received in an RRC configuration message, or in a broadcast message such as system information. The configuration may configure the UE to perform one or more of the actions set out above with respect to FIG. 4.

The UE may be configured as set out herein responsive to a determination that the UE is capable of performing one or more actions as described below. That is, on connection to the communication network, the UE may report its capabilities to the network. The capabilities may include an indication that the UE is capable of performing conditional cell change procedures (such as CPA or CPC, defined above), and/or that the UE is capable of storing a conditional cell reconfiguration towards a current serving cell.

For example, the UE may transmit to the network at least one capability information indicating to the network that the UE is capable of receiving a conditional reconfiguration including a target candidate cell which is the same as the current serving cell. Then, the network configures the UE with conditional configurations, where one of the target candidates is the current serving cell (e.g. UE's PSCell) is based on the received UE capability information.

The UE is configured to associate a stored configuration for the first, serving cell with a condition for executing a cell change procedure to the first cell. For example, the stored configuration may comprise a RRC reconfiguration message for the first cell (e.g., RRCReconfiguration* message). For example, the network node may transmit a conditional reconfiguration message, corresponding to the first cell, to the UE.

Thus the UE is configured to store a conditional reconfiguration associated with its currently serving cell (i.e., the first cell). The conditional reconfiguration comprises a configuration (e.g., an RRC configuration) to be applied upon executing a cell change procedure to the first cell, and a corresponding condition, upon fulfilment of which, the UE executes the cell change procedure to the first cell. The conditional reconfiguration may correspond to a Conditional PSCell Change (CPC) configuration with the target PSCell (also called a target candidate PSCell) being the same as the current serving PSCell, i.e., the first cell (which may be called source PSCell). In another set of embodiments, the conditional reconfiguration may correspond to a Conditional Handover (CHO) configuration with the target PCell (also called a target candidate PCell) being the same as the current serving PCell, i.e., the first cell. In a further embodiment, the conditional reconfiguration may correspond to conditional PSCell addition (CPA), with the new PSCell corresponding to the first cell.

The condition for executing the cell change procedure may be associated with one or more radio measurements (e.g., reference signal received power, reference signal received quality, SNR, etc) performed on transmissions by the first cell and one or more neighbouring cells. For example, the condition may comprise one or more thresholds applied to radio measurements of the first cell, radio measurements of the neighbour cell(s) and/or a difference between radio measurements of the first cell and the neighbour cell(s) (e.g., RSRP for the first cell is X dB greater than RSRP for the neighbour cell, etc). Note that, in this context, one of the neighbouring cells may have become a serving cell by the time that the condition is monitored and/or the cell change procedure to the first cell is executed. The one or more radio measurements may be specified in a measurement configuration that is associated with the first cell and/or the second cell (and/or the stored configuration).

The stored configuration may be associated with more than one condition. For example, the stored configuration may be associated with a first condition, which is associated with changing from a second cell (e.g., a particular cell) to the first cell, and a second condition, which is associated with changing from a third cell to the first cell. That is, the UE may apply different conditions for changing to the first cell depending on the cell that becomes its serving cell. In one embodiment, the stored configuration is associated with a plurality of conditions, with each condition being associated with a cell change procedure from a respective cell to the first cell.

Prior to executing the cell change procedure away from the first cell, the UE may be configured to refrain from monitoring the condition. In this option, therefore, upon reception and/or storing of the conditional reconfiguration, the UE monitors the execution condition associated to a target candidate cell only if the target candidate cell is a cell which is not the current serving cell. For example, the UE monitors the execution condition associated to a target candidate cell only if the cell identifier (e.g. PCI) of the target candidate cell is not the same as the cell identifier (e.g. PCI) of the current serving cell AND the frequency (e.g. Synchronization Signal Block (SSB) frequency) of the target candidate cell is not the same as the frequency (e.g. SSB frequency) of the current serving cell.

Alternatively or additionally, the UE may be configured to, upon reception and/or storing of the conditional reconfiguration, consider a candidate cell an applicable cell i.e. a valid candidate to be monitored, only if the target candidate cell is a cell which is not the current serving cell. For example, the UE considers a candidate cell as an applicable cell only if the cell identifier (e.g. PCI) of the target candidate cell is not the same as the cell identifier (e.g. PCI) of the current serving cell AND the frequency (e.g. Synchronization Signal Block (SSB) frequency) of the target candidate cell is not the same as the frequency (e.g. SSB frequency) of the current serving cell.

In another embodiment, the UE may be configured to, prior to executing the cell change procedure away from the first cell, refrain from executing or triggering the cell change procedure to the first cell. In this case, the condition for executing the cell change procedure to the first cell may be monitored by the UE.

For example, the UE may be configured to perform evaluation of the execution conditions associated to the conditional reconfiguration even if the included target cell is the same as the current serving cell, but it does then not trigger any execution of the included configuration even if the execution conditions are fulfilled. If the conditional reconfiguration is then kept when the UE moves to another cell, i.e. where the target cell included in the conditional reconfiguration is no longer the same as the current serving cell, the UE will then (in that other serving cell) perform evaluation of, and can then also trigger execution of, the conditional reconfiguration.

In one alternative where the UE is configured with a conditional reconfiguration where the included target candidate cell is the same as the current serving cell, the UE also checks the conditional event(s) that is/are associated to (the execution conditions for) the conditional reconfiguration so that the evaluation and/or triggering of the execution of the conditional reconfiguration is only skipped for some types of conditional events. In one example, the UE then skips evaluation of and/or triggering execution of the conditional reconfiguration if the conditional event is any of a CondEvent A3 (or event A3), i.e. that “Neighbour becomes offset better than SpCell” or a CondEvent A5 (or event A5), i.e. that “SpCell becomes worse than threshold1 and neighbour becomes better than threshold2”. In these cases the execution conditions for the conditional reconfiguration are related to that a neighbour cell (the candidate target cell in case of a conditional reconfiguration) becomes better than the serving cell (i.e. the SpCell). In one example, the UE skips evaluation of and/or triggering execution of the conditional reconfiguration (where the included target cell is the same as the current serving cell) if the conditional event is a CondEvent A4 (or event A4), i.e. that “Neighbour becomes better than threshold”.

Thus, the UE may receive an indication from the network whether to skip evaluation and/or triggering of the execution of the conditional reconfiguration in case the target cell for the conditional reconfiguration is the same as the current serving cell. In one example, if the network has set the indication and the target cell that is included in the conditional reconfiguration is the same as the current serving cell, the UE skips evaluation of and/or triggering execution of the conditional reconfiguration. If the network has not set the indication, the UE then however performs evaluation of, and can also trigger execution of, the conditional reconfiguration even if the included target cell is the same as the current serving cell. In one example, the indication from the network can be included within, or together with, conditional reconfiguration so that the indication is valid for a specific conditional reconfiguration. In one other example, the indication from the network is valid for several conditional reconfigurations, such as for all the conditional reconfigurations that the UE is configured with or for all conditional reconfigurations of a certain type.

In one embodiment the UE is thus configured with conditional reconfigurations, where one of the target candidates is the current PSCell,

In this option, the UE is configured with a conditional reconfiguration for the current PSCell. That means that the UE may receive a configuration for the current PSCell, conditional configurations for other target candidate PSCells and also a CPC configuration for the current PSCell. The CPC configuration for the current PSCell comprises execution conditions for CPC and a configuration to apply when the conditions are fulfilled.

In one option, the configuration to be applied may be an indication indicating that the UE may use the current PSCell configuration as configuration that is applied when the conditions are fulfilled.

In one option, the UE only receives the conditions and the configuration to be applied when the UE returns to the current PSCell is the current PSCell configuration.

The conditions may initially be “deactivated” as long as the UE remains in the current/first PSCell. When the UE has changed PSCell to a second PSCell, the conditions for returning to the first PSCell may become “activated”.

The disclosure includes methods for network nodes to configure the UE with information about what conditional reconfiguration(s) to keep/store for the serving cell before execution of another mobility procedure. This disclosure also includes methods for network nodes to query the UE about the stored conditional reconfiguration(s) and suggest the candidate cells to the UE for another mobility procedure.

In one embodiment, during conditional reconfiguration, e.g., Conditional PSCell Change, the MN indicates to the UE to keep or release the conditional configuration for the current serving PSCell. The MN may receive a confirmation from the UE via a RRC message.

In another embodiment, after execution of mobility procedure, i.e., the serving cell has changed, the MN sends a RRC message to the UE to query whether it has the conditional configuration(s) for the certain serving cell(s), i.e., the candidate cells.

In one example the MN receives the message from the UE via either an explicit indicator or a new message to say that the UE has the information on conditional configurations for the candidate cell(s).

In another example, the MN receives the message from the UE via either an explicit indicator or a failure message to say that the UE has no information on conditional configuration(s) for the candidate cell(s).

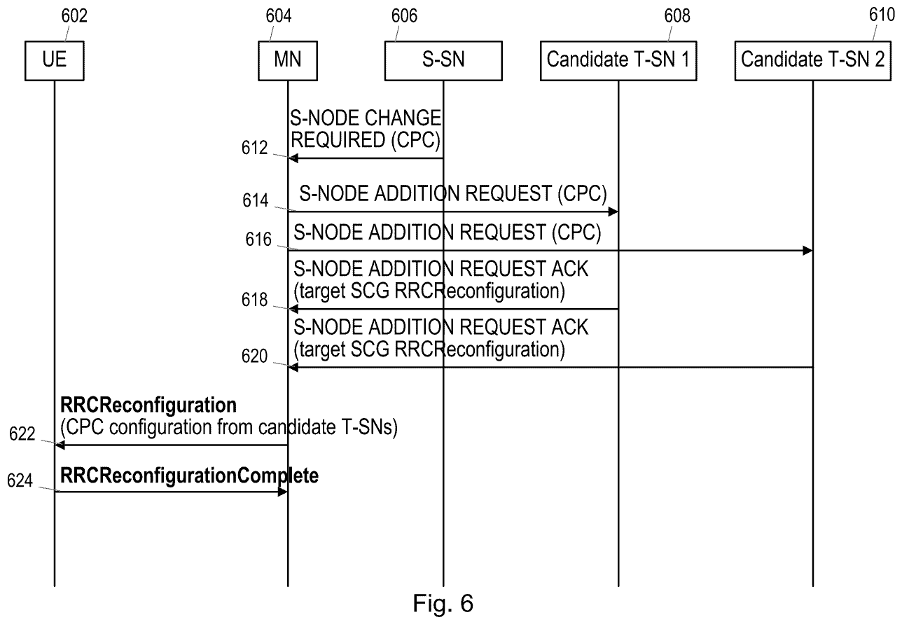

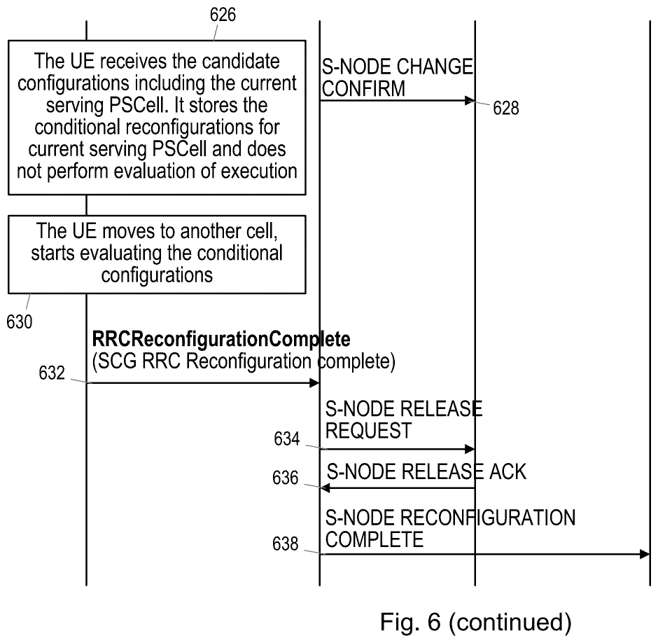

FIG. 6 illustrates an example signaling flow for storing conditional configurations for current serving PSCell, and involves a UE 602, an MN 604, an S-SN 606, a candidate T-SN 1 608, and a Candidate T-SN 2 610.

At step 612, the S-SN 606 sends an S-NODE CHANGE REQUIRED (CPC) message to the MN 604.

At step 614, the MN 604 sends an S-NODE ADDITION REQUEST (CPC) message to the Candidate T-SN 1 608.

At step 616, the MN 604 sends an S-NODE ADDITION REQUEST (CPC) message to the Candidate T-SN 2 610.

At step 618, the Candidate T-SN 1 608 sends an S-NODE ADDITION REQUEST ACK (target SCG RRCReconfiguration) message to the MN 604.

At step 620, the Candidate T-SN 2 610 sends an S-NODE ADDITION REQUEST ACK (target SCG RRCReconfiguration) message to the MN 604.

At step 622, the MN 604 sends an RRCReconfiguration (CPC configuration from candidate T-SNs) message to the UE 602.

At step 624, the UE 602 sends an RRCReconfigurationComplete message to the MN 604.

At step 626, the UE receives the candidate configurations including the current serving PSCell. It stores the conditional reconfigurations for current serving PSCell and does not perform evaluation of execution.

At step 628, the MN 604 sends an S-NODE CHANGE CONFIRM message to the S-SN 606.

At step 630, the UE moves to another cell and starts evaluating the conditional configurations.

At step 632, the UE 602 sends an RRCReconfigurationComplete (SCG RRC reconfiguration complete) message to the MN 604.

At step 634, the MN 604 sends an S-NODE RELEASE REQUEST message to the S-SN 606.

At step 636, the S-SN 606 sends an S-NODE RELEASE ACK message to the MN 604.

At step 638, the MN 604 sends an S-NODE RECONFIGURATION COMPLETE message to the Candidate T-SN 1 608.

Below is an example implementation in 3GPP TS 38.331, using underlined text, for the procedure where the UE does not perform evaluation of the conditional reconfiguration if the current serving cell is the target cell, e.g. if the current serving PSCell is the target cell in a CPC configuration or the current serving PCell is the target cell of a CHO configuration.

### 5.3.5.13.4 Conditional Reconfiguration Evaluation

The UE shall:
1> for each condReconfigId within the VarConditionalReconfig:
2> if the RRCReconfiguration within condRRCReconfig includes the masterCellGroup including the reconfigurationWithSync, consider the cell which has a physical cell identity matching the value indicated in the ServingCellConfigCommon included in the reconfigurationWithSync within the masterCellGroup in the received condRRCReconfig to be applicable cell;
2> if the RRCReconfiguration within condRRCReconfig includes the secondaryCellGroup including the reconfigurationWithSync, consider the cell which has a physical cell identity matching the value indicated in the ServingCellConfigCommon included in the reconfigurationWithSync within the secondaryCellGroup within the received condRRCReconfig to be applicable cell;
2> if condExecutionCondSCG is configured:
3> in the remainder of the procedures, consider each measId indicated in the condExecutionCondSCG as a measId in the VarMeasConfig associated with the SCG measConfig;
2> if condExecutionCond is configured:
3> if it is configured via SRB3 or configured within nr-SCG or within nr-SecondaryCellGroupConfig (specified in TS 36.331 [10]) via SRB1:
4> in the remainder of the procedures, consider each measId indicated in the condExecutionCond as a measId in the VarMeasConfig associated with the SCG measConfig;
3> otherwise:
4> in the remainder of the procedures, consider each measId indicated in the condExecutionCond as a measId in the VarMeasConfig associated with the MCG measConfig;
2> if the applicable cell is the same as the current serving PCell or the current serving PSCell:
3> no evaluation shall be performed for the conditional reconfiguration within VarConditionalReconfig with the corresponding condReconfigId:
2> else for each measId included in the measIdList within VarMeasConfig indicated in the condExecutionCond or condExecutionCondSCG associated to condReconfigId:
3> if the condEventId is associated with condEventT1, and if the entry condition(s) applicable for this event associated with the condReconfigId, i.e. the event corresponding with the condEventId(s) of the corresponding condTriggerConfig within VarConditionalReconfig, is fulfilled for the applicable cells; or
3> if the condEventId is associated with condEventD1, and if the entry condition(s) applicable for this event associated with the condReconfigId, i.e. the event corresponding with the condEventId(s) of the corresponding condTriggerConfig within VarConditionalReconfig, is fulfilled for the applicable cells during the corresponding timeToTrigger defined for this event within the VarConditionalReconfig; or
3> if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be fulfilled;
3> if the measId for this event associated with the condReconfigId has been modified; or
3> if the condEventId is associated with condEventT1, and if the leaving condition(s) applicable for this event associated with the condReconfigId, i.e. the event corresponding with the condEventId(s) of the corresponding condTriggerConfig within VarConditionalReconfig, is fulfilled for the applicable cells; or
3> if the condEventId is associated with condEventD1, and if the leaving condition(s) applicable for this event associated with the condReconfigId, i.e. the event corresponding with the condEventId(s) of the corresponding condTriggerConfig within VarConditionalReconfig, is fulfilled for the applicable cells during the corresponding timeToTrigger defined for this event within the VarConditionalReconfig; or
3> if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4> consider the event associated to that measId to be not fulfilled;
2> if event(s) associated to all measId(s) within condTriggerConfig for a target candidate cell within the stored condRRCReconfig are fulfilled:
3> consider the target candidate cell within the stored condRRCReconfig, associated to that condReconfigId, as a triggered cell;
3> initiate the conditional reconfiguration execution, as specified in 5.3.5.13.5;
NOTE: Up to 2 MeasId can be configured for each condReconfigId. The conditional reconfiguration event of the 2 MeasId may have the same or different event conditions, triggering quantity, time to trigger, and triggering threshold.

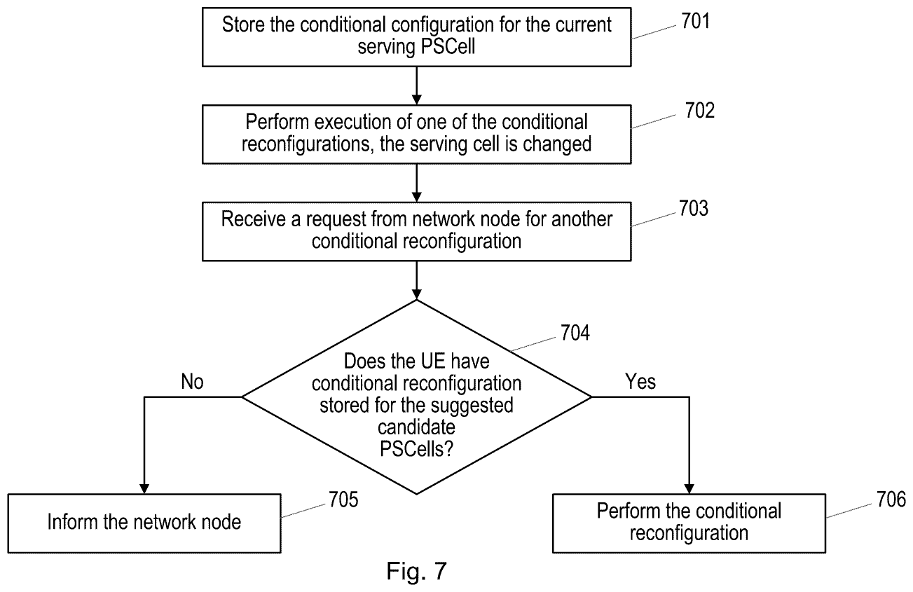

FIG. 7 illustrates the main steps performed by the UE in one example of the disclosure.

Step 701. The UE chooses to store the conditional configuration for the current serving PSCell, either based on its own capability, or an indication from the network.

Step 702. After the first execution of CPC, the UE changes the serving cell.

Step 703. The network node sends another RRC message to the UE for another mobility procedure

Step 704. Check if the UE has the stored conditional configuration for one candidate PSCell, which is one of the previous serving cell(s).

Step 705. The UE has no stored conditional configuration, and informs the network node.

Step 706. The UE has the stored conditional configuration for the candidate PSCell, and would be able to perform the conditional reconfiguration.

FIG. 8 shows an example of a communication system 800 in accordance with some embodiments.

In the example, the communication system 800 includes a telecommunication network 802 that includes an access network 804, such as a radio access network (RAN), and a core network 806, which includes one or more core network nodes 808. The access network 804 includes one or more access network nodes, such as network nodes 810a and 810b (one or more of which may be generally referred to as network nodes 810), or any other similar 3rd Generation Partnership Project (3GPP) access node or non-3GPP access point. The network nodes 810 facilitate direct or indirect connection of user equipment (UE), such as by connecting UEs 812a, 812b, 812c, and 812d (one or more of which may be generally referred to as UEs 812) to the core network 806 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 800 may include any number of wired or wireless networks, network nodes, UEs, and/or any other components or systems that may facilitate or participate in the communication of data and/or signals whether via wired or wireless connections. The communication system 800 may include and/or interface with any type of communication, telecommunication, data, cellular, radio network, and/or other similar type of system.

The UEs 812 may be any of a wide variety of communication devices, including wireless devices arranged, configured, and/or operable to communicate wirelessly with the network nodes 810 and other communication devices. Similarly, the network nodes 810 are arranged, capable, configured, and/or operable to communicate directly or indirectly with the UEs 812 and/or with other network nodes or equipment in the telecommunication network 802 to enable and/or provide network access, such as wireless network access, and/or to perform other functions, such as administration in the telecommunication network 802.

In the depicted example, the core network 806 connects the network nodes 810 to one or more hosts, such as host 816. These connections may be direct or indirect via one or more intermediary networks or devices. In other examples, network nodes may be directly coupled to hosts. The core network 806 includes one more core network nodes (e.g., core network node 808) that are structured with hardware and software components. Features of these components may be substantially similar to those described with respect to the UEs, network nodes, and/or hosts, such that the descriptions thereof are generally applicable to the corresponding components of the core network node 808. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 816 may be under the ownership or control of a service provider other than an operator or provider of the access network 804 and/or the telecommunication network 802, and may be operated by the service provider or on behalf of the service provider. The host 816 may host a variety of applications to provide one or more services. Examples of such applications include the provision of live and/or pre-recorded audio/video content, data collection services, for example, retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 800 of FIG. 8 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 802 is a cellular network that implements 3GPP standardized features. Accordingly, the telecommunications network 802 may support network slicing to provide different logical networks to different devices that are connected to the telecommunication network 802. For example, the telecommunications network 802 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 812 are configured to transmit and/or receive information without direct human interaction. For instance, a UE may be designed to transmit information to the access network 804 on a predetermined schedule, when triggered by an internal or external event, or in response to requests from the access network 804. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example illustrated in FIG. 8, the hub 814 communicates with the access network 804 to facilitate indirect communication between one or more UEs (e.g., UE 812c and/or 812d) and network nodes (e.g., network node 810b). In some examples, the hub 814 may be a controller, router, a content source and analytics node, or any of the other communication devices described herein regarding UEs. For example, the hub 814 may be a broadband router enabling access to the core network 806 for the UEs. As another example, the hub 814 may be a controller that sends commands or instructions to one or more actuators in the UEs. Commands or instructions may be received from the UEs, network nodes 810, or by executable code, script, process, or other instructions in the hub 814. As another example, the hub 814 may be a data collector that acts as temporary storage for UE data and, in some embodiments, may perform analysis or other processing of the data. As another example, the hub 814 may be a content source. For example, for a UE that is a VR headset, display, loudspeaker or other media delivery device, the hub 814 may retrieve VR assets, video, audio, or other media or data related to sensory information via a network node, which the hub 814 then provides to the UE either directly, after performing local processing, and/or after adding additional local content. In still another example, the hub 814 acts as a proxy server or orchestrator for the UEs, in particular in if one or more of the UEs are low energy IoT devices.

The hub 814 may have a constant/persistent or intermittent connection to the network node 810b. The hub 814 may also allow for a different communication scheme and/or schedule between the hub 814 and UEs (e.g., UE 812c and/or 812d), and between the hub 814 and the core network 806. In other examples, the hub 814 is connected to the core network 806 and/or one or more UEs via a wired connection. Moreover, the hub 814 may be configured to connect to an M2M service provider over the access network 804 and/or to another UE over a direct connection. In some scenarios, UEs may establish a wireless connection with the network nodes 810 while still connected via the hub 814 via a wired or wireless connection. In some embodiments, the hub 814 may be a dedicated hub—that is, a hub whose primary function is to route communications to/from the UEs from/to the network node 810b. In other embodiments, the hub 814 may be a non-dedicated hub—that is, a device which is capable of operating to route communications between the UEs and network node 810b, but which is additionally capable of operating as a communication start and/or end point for certain data channels.

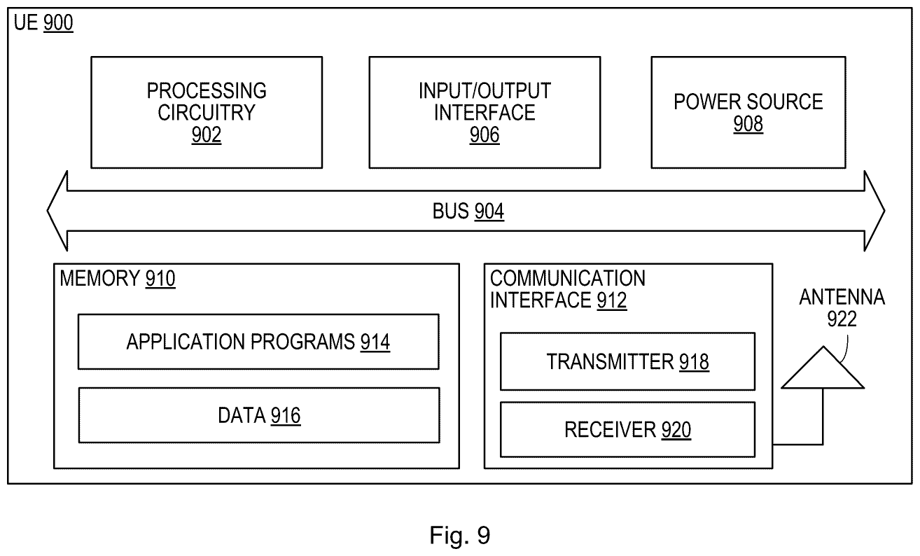

FIG. 9 shows a UE 900 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless camera, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 900 includes processing circuitry 902 that is operatively coupled via a bus 904 to an input/output interface 906, a power source 908, a memory 910, a communication interface 912, and/or any other component, or any combination thereof. Certain UEs may utilize all or a subset of the components shown in FIG. 9. The level of integration between the components may vary from one UE to another UE. Further, certain UEs may contain multiple instances of a component, such as multiple processors, memories, transceivers, transmitters, receivers, etc.

The processing circuitry 902 is configured to process instructions and data and may be configured to implement any sequential state machine operative to execute instructions stored as machine-readable computer programs in the memory 910. The processing circuitry 902 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 902 may include multiple central processing units (CPUs). The processing circuitry 902 may be operable to provide, either alone or in conjunction with other UE 900 components, such as the memory 910, UE 900 functionality. For example, the processing circuitry 902 may be configured to cause the UE 902 to perform the methods as described with reference to any one of FIGS. 4 and 7, and/or the signalling and processing described with reference to the UE of FIG. 6.

In the example, the input/output interface 906 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 900. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 908 is structured as a battery or battery pack. Other types of power sources, such as an external power source (e.g., an electricity outlet), photovoltaic device, or power cell, may be used. The power source 908 may further include power circuitry for delivering power from the power source 908 itself, and/or an external power source, to the various parts of the UE 900 via input circuitry or an interface such as an electrical power cable. Delivering power may be, for example, for charging of the power source 908. Power circuitry may perform any formatting, converting, or other modification to the power from the power source 908 to make the power suitable for the respective components of the UE 900 to which power is supplied.

The memory 910 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 910 includes one or more application programs 914, such as an operating system, web browser application, a widget, gadget engine, or other application, and corresponding data 916. The memory 910 may store, for use by the UE 900, any of a variety of various operating systems or combinations of operating systems.

The memory 910 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 910 may allow the UE 900 to access instructions, application programs and the like, stored on transitory or non-transitory memory media, to off-load data, or to upload data. An article of manufacture, such as one utilizing a communication system may be tangibly embodied as or in the memory 910, which may be or comprise a device-readable storage medium.

The processing circuitry 902 may be configured to communicate with an access network or other network using the communication interface 912. The communication interface 912 may comprise one or more communication subsystems and may include or be communicatively coupled to an antenna 922. The communication interface 912 may include one or more transceivers used to communicate, such as by communicating with one or more remote transceivers of another device capable of wireless communication (e.g., another UE or a network node in an access network). Each transceiver may include a transmitter 918 and/or a receiver 920 appropriate to provide network communications (e.g., optical, electrical, frequency allocations, and so forth). Moreover, the transmitter 918 and receiver 920 may be coupled to one or more antennas (e.g., antenna 922) and may share circuit components, software or firmware, or alternatively be implemented separately.

In some embodiments, communication functions of the communication interface 912 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 912, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or controls a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are devices which are or which are embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence on the intended application of the IoT device in addition to other components as described in relation to the UE 900 shown in FIG. 9.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 10 shows a network node 1000 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1000 includes processing circuitry 1002, a memory 1004, a communication interface 1006, and a power source 1008, and/or any other component, or any combination thereof. The network node 1000 may be composed of multiple physically separate components (e.g., a NodeB component and a RNC component, or a BTS component and a BSC component, etc.), which may each have their own respective components. In certain scenarios in which the network node 1000 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1000 may be configured to support multiple radio access technologies (RATs). In such embodiments, some components may be duplicated (e.g., separate memory 1004 for different RATs) and some components may be reused (e.g., a same antenna 1010 may be shared by different RATs). The network node 1000 may also include multiple sets of the various illustrated components for different wireless technologies integrated into network node 1000, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1000.

The processing circuitry 1002 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1000 components, such as the memory 1004, network node 1000 functionality. For example, the processing circuitry 1002 may be configured to cause the network node to perform the methods as described with reference to FIG. 5, and/or the signalling and processing described with reference to any one of the MN, S-SN, Candidate T-SN 1 and Candidate T-SN 2 units of FIG. 6.

In some embodiments, the processing circuitry 1002 includes a system on a chip (SOC). In some embodiments, the processing circuitry 1002 includes one or more of radio frequency (RF) transceiver circuitry 1012 and baseband processing circuitry 1014. In some embodiments, the radio frequency (RF) transceiver circuitry 1012 and the baseband processing circuitry 1014 may be on separate chips (or sets of chips), boards, or units, such as radio units and digital units. In alternative embodiments, part or all of RF transceiver circuitry 1012 and baseband processing circuitry 1014 may be on the same chip or set of chips, boards, or units.

The memory 1004 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1002. The memory 1004 may store any suitable instructions, data, or information, including a computer program, software, an application including one or more of logic, rules, code, tables, and/or other instructions capable of being executed by the processing circuitry 1002 and utilized by the network node 1000. The memory 1004 may be used to store any calculations made by the processing circuitry 1002 and/or any data received via the communication interface 1006. In some embodiments, the processing circuitry 1002 and memory 1004 is integrated.

The communication interface 1006 is used in wired or wireless communication of signaling and/or data between a network node, access network, and/or UE. As illustrated, the communication interface 1006 comprises port(s)/terminal(s) 1016 to send and receive data, for example to and from a network over a wired connection. The communication interface 1006 also includes radio front-end circuitry 1018 that may be coupled to, or in certain embodiments a part of, the antenna 1010. Radio front-end circuitry 1018 comprises filters 1020 and amplifiers 1022. The radio front-end circuitry 1018 may be connected to an antenna 1010 and processing circuitry 1002. The radio front-end circuitry may be configured to condition signals communicated between antenna 1010 and processing circuitry 1002. The radio front-end circuitry 1018 may receive digital data that is to be sent out to other network nodes or UEs via a wireless connection. The radio front-end circuitry 1018 may convert the digital data into a radio signal having the appropriate channel and bandwidth parameters using a combination of filters 1020 and/or amplifiers 1022. The radio signal may then be transmitted via the antenna 1010. Similarly, when receiving data, the antenna 1010 may collect radio signals which are then converted into digital data by the radio front-end circuitry 1018. The digital data may be passed to the processing circuitry 1002. In other embodiments, the communication interface may comprise different components and/or different combinations of components.

In certain alternative embodiments, the network node 1000 does not include separate radio front-end circuitry 1018, instead, the processing circuitry 1002 includes radio front-end circuitry and is connected to the antenna 1010. Similarly, in some embodiments, all or some of the RF transceiver circuitry 1012 is part of the communication interface 1006. In still other embodiments, the communication interface 1006 includes one or more ports or terminals 1016, the radio front-end circuitry 1018, and the RF transceiver circuitry 1012, as part of a radio unit (not shown), and the communication interface 1006 communicates with the baseband processing circuitry 1014, which is part of a digital unit (not shown).

The antenna 1010 may include one or more antennas, or antenna arrays, configured to send and/or receive wireless signals. The antenna 1010 may be coupled to the radio front-end circuitry 1018 and may be any type of antenna capable of transmitting and receiving data and/or signals wirelessly. In certain embodiments, the antenna 1010 is separate from the network node 1000 and connectable to the network node 1000 through an interface or port.

The antenna 1010, communication interface 1006, and/or the processing circuitry 1002 may be configured to perform any receiving operations and/or certain obtaining operations described herein as being performed by the network node. Any information, data and/or signals may be received from a UE, another network node and/or any other network equipment. Similarly, the antenna 1010, the communication interface 1006, and/or the processing circuitry 1002 may be configured to perform any transmitting operations described herein as being performed by the network node. Any information, data and/or signals may be transmitted to a UE, another network node and/or any other network equipment.

The power source 1008 provides power to the various components of network node 1000 in a form suitable for the respective components (e.g., at a voltage and current level needed for each respective component). The power source 1008 may further comprise, or be coupled to, power management circuitry to supply the components of the network node 1000 with power for performing the functionality described herein. For example, the network node 1000 may be connectable to an external power source (e.g., the power grid, an electricity outlet) via an input circuitry or interface such as an electrical cable, whereby the external power source supplies power to power circuitry of the power source 1008. As a further example, the power source 1008 may comprise a source of power in the form of a battery or battery pack which is connected to, or integrated in, power circuitry. The battery may provide backup power should the external power source fail.

Embodiments of the network node 1000 may include additional components beyond those shown in FIG. 10 for providing certain aspects of the network node's functionality, including any of the functionality described herein and/or any functionality necessary to support the subject matter described herein. For example, the network node 1000 may include user interface equipment to allow input of information into the network node 1000 and to allow output of information from the network node 1000. This may allow a user to perform diagnostic, maintenance, repair, and other administrative functions for the network node 1000.

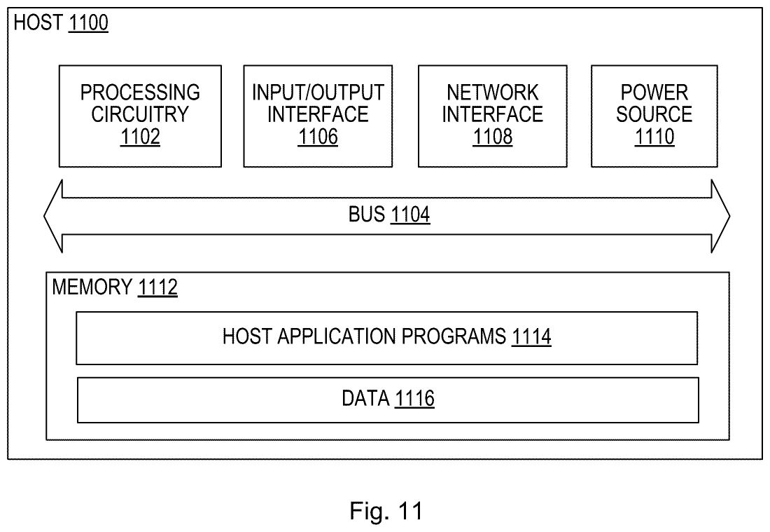

FIG. 11 is a block diagram of a host 1100, which may be an embodiment of the host 816 of FIG. 8, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 9 and 10, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

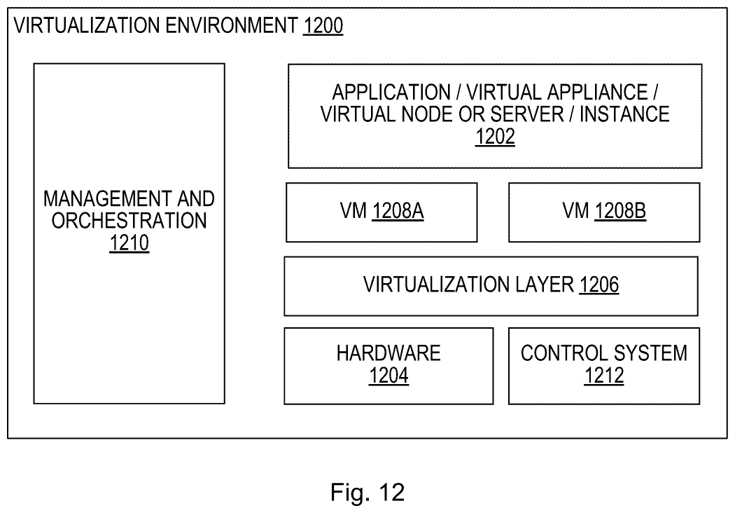

FIG. 12 is a block diagram illustrating a virtualization environment 1200 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1200 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1202 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1204 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1206 (also referred to as hypervisors or virtual machine monitors (VMMs)), provide VMs 1208a and 1208b (one or more of which may be generally referred to as VMs 1208), and/or perform any of the functions, features and/or benefits described in relation with some embodiments described herein. The virtualization layer 1206 may present a virtual operating platform that appears like networking hardware to the VMs 1208.

The VMs 1208 comprise virtual processing, virtual memory, virtual networking or interface and virtual storage, and may be run by a corresponding virtualization layer 1206. Different embodiments of the instance of a virtual appliance 1202 may be implemented on one or more of VMs 1208, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1208 may be a software implementation of a physical machine that runs programs as if they were executing on a physical, non-virtualized machine. Each of the VMs 1208, and that part of hardware 1204 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1208 on top of the hardware 1204 and corresponds to the application 1202.

Hardware 1204 may be implemented in a standalone network node with generic or specific components. Hardware 1204 may implement some functions via virtualization. Alternatively, hardware 1204 may be part of a larger cluster of hardware (e.g. such as in a data center or CPE) where many hardware nodes work together and are managed via management and orchestration 1210, which, among others, oversees lifecycle management of applications 1202. In some embodiments, hardware 1204 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1212 which may alternatively be used for communication between hardware nodes and radio units.

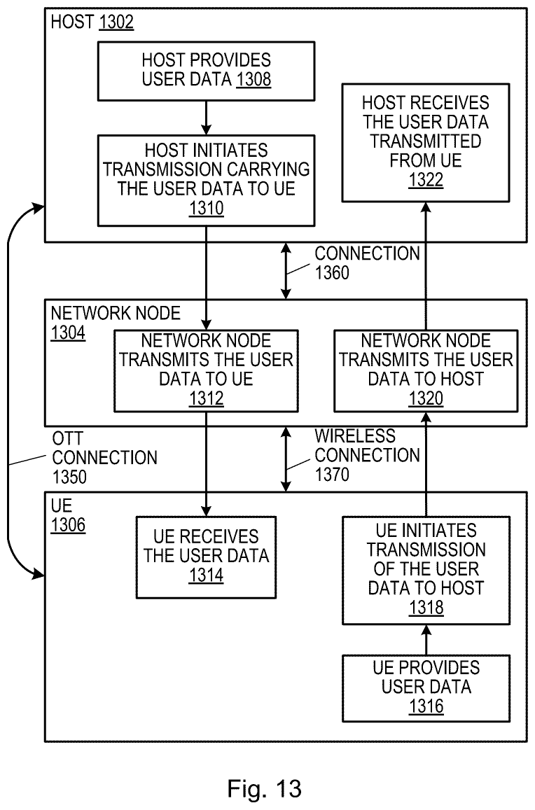

FIG. 13 shows a communication diagram of a host 1302 communicating via a network node 1304 with a UE 1306 over a partially wireless connection in accordance with some embodiments. Example implementations, in accordance with various embodiments, of the UE (such as a UE 812a of FIG. 8 and/or UE 900 of FIG. 9), network node (such as network node 810a of FIG. 8 and/or network node 1000 of FIG. 10), and host (such as host 816 of FIG. 8 and/or host 1100 of FIG. 11) discussed in the preceding paragraphs will now be described with reference to FIG. 13.

Like host 1100, embodiments of host 1302 include hardware, such as a communication interface, processing circuitry, and memory. The host 1302 also includes software, which is stored in or accessible by the host 1302 and executable by the processing circuitry. The software includes a host application that may be operable to provide a service to a remote user, such as the UE 1306 connecting via an over-the-top (OTT) connection 1350 extending between the UE 1306 and host 1302. In providing the service to the remote user, a host application may provide user data which is transmitted using the OTT connection 1350.

The network node 1304 includes hardware enabling it to communicate with the host 1302 and UE 1306. The connection 1360 may be direct or pass through a core network (like core network 806 of FIG. 8) and/or one or more other intermediate networks, such as one or more public, private, or hosted networks. For example, an intermediate network may be a backbone network or the Internet.

The UE 1306 includes hardware and software, which is stored in or accessible by UE 1306 and executable by the UE's processing circuitry. The software includes a client application, such as a web browser or operator-specific “app” that may be operable to provide a service to a human or non-human user via UE 1306 with the support of the host 1302. In the host 1302, an executing host application may communicate with the executing client application via the OTT connection 1350 terminating at the UE 1306 and host 1302. In providing the service to the user, the UE's client application may receive request data from the host's host application and provide user data in response to the request data. The OTT connection 1350 may transfer both the request data and the user data. The UE's client application may interact with the user to generate the user data that it provides to the host application through the OTT connection 1350.

The OTT connection 1350 may extend via a connection 1360 between the host 1302 and the network node 1304 and via a wireless connection 1370 between the network node 1304 and the UE 1306 to provide the connection between the host 1302 and the UE 1306. The connection 1360 and wireless connection 1370, over which the OTT connection 1350 may be provided, have been drawn abstractly to illustrate the communication between the host 1302 and the UE 1306 via the network node 1304, without explicit reference to any intermediary devices and the precise routing of messages via these devices.

As an example of transmitting data via the OTT connection 1350, in step 1308, the host 1302 provides user data, which may be performed by executing a host application. In some embodiments, the user data is associated with a particular human user interacting with the UE 1306. In other embodiments, the user data is associated with a UE 1306 that shares data with the host 1302 without explicit human interaction. In step 1310, the host 1302 initiates a transmission carrying the user data towards the UE 1306. The host 1302 may initiate the transmission responsive to a request transmitted by the UE 1306. The request may be caused by human interaction with the UE 1306 or by operation of the client application executing on the UE 1306. The transmission may pass via the network node 1304, in accordance with the teachings of the embodiments described throughout this disclosure. Accordingly, in step 1312, the network node 1304 transmits to the UE 1306 the user data that was carried in the transmission that the host 1302 initiated, in accordance with the teachings of the embodiments described throughout this disclosure. In step 1314, the UE 1306 receives the user data carried in the transmission, which may be performed by a client application executed on the UE 1306 associated with the host application executed by the host 1302.

In some examples, the UE 1306 executes a client application which provides user data to the host 1302. The user data may be provided in reaction or response to the data received from the host 1302. Accordingly, in step 1316, the UE 1306 may provide user data, which may be performed by executing the client application. In providing the user data, the client application may further consider user input received from the user via an input/output interface of the UE 1306. Regardless of the specific manner in which the user data was provided, the UE 1306 initiates, in step 1318, transmission of the user data towards the host 1302 via the network node 1304. In step 1320, in accordance with the teachings of the embodiments described throughout this disclosure, the network node 1304 receives user data from the UE 1306 and initiates transmission of the received user data towards the host 1302. In step 1322, the host 1302 receives the user data carried in the transmission initiated by the UE 1306.

One or more of the various embodiments improve the performance of OTT services provided to the UE 1306 using the OTT connection 1350, in which the wireless connection 1370 forms the last segment. More precisely, the teachings of these embodiments may improve the latency and power consumption of user equipment (e.g., by reducing signalling overhead associated with conditional cell change procedures) and thereby provide benefits such as reduced user waiting time, better responsiveness and extended battery lifetime.

In an example scenario, factory status information may be collected and analyzed by the host 1302. As another example, the host 1302 may process audio and video data which may have been retrieved from a UE for use in creating maps. As another example, the host 1302 may collect and analyze real-time data to assist in controlling vehicle congestion (e.g., controlling traffic lights). As another example, the host 1302 may store surveillance video uploaded by a UE. As another example, the host 1302 may store or control access to media content such as video, audio, VR or AR which it can broadcast, multicast or unicast to UEs. As other examples, the host 1302 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1350 between the host 1302 and UE 1306, in response to variations in the measurement results. The measurement procedure and/or the network functionality for reconfiguring the OTT connection may be implemented in software and hardware of the host 1302 and/or UE 1306. In some embodiments, sensors (not shown) may be deployed in or in association with other devices through which the OTT connection 1350 passes; the sensors may participate in the measurement procedure by supplying values of the monitored quantities exemplified above, or supplying values of other physical quantities from which software may compute or estimate the monitored quantities. The reconfiguring of the OTT connection 1350 may include message format, retransmission settings, preferred routing etc.; the reconfiguring need not directly alter the operation of the network node 1304. Such procedures and functionalities may be known and practiced in the art. In certain embodiments, measurements may involve proprietary UE signaling that facilitates measurements of throughput, propagation times, latency and the like, by the host 1302. The measurements may be implemented in that software causes messages to be transmitted, in particular empty or ‘dummy’ messages, using the OTT connection 1350 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

For the avoidance of doubt, the following numbered statements set out embodiments of the disclosure:

### Group A Embodiments

1. A method performed by a user equipment, the method comprising:
   associating a stored configuration for a first serving cell with a condition for executing a cell change procedure to the first cell; and
   after executing a cell change procedure away from the first cell, monitoring the condition.
2. The method of embodiment 1, further comprising, upon fulfilment of the condition, executing the cell change procedure to the first cell.
3. The method of embodiment 1 or 2, wherein one or more of the associating step and the monitoring step are performed responsive to configuration by a network node.
4. The method of embodiment 3, wherein the network node is a serving network node for the first cell.
5. The method of any one of the preceding embodiments, wherein the cell change procedure away from the first cell comprises a cell change from the first cell to a second cell, and wherein the cell change procedure to the first cell comprises a cell change from the second cell to the first cell.
6. The method of embodiment 5, wherein the stored configuration is associated with a first condition and a second condition, wherein the first condition is for executing the cell change procedure to the first cell from the second cell, and wherein the second condition is for executing a cell change procedure to the first cell from a third cell.
7. The method of embodiment 5, wherein the stored configuration is associated with a plurality of conditions, and wherein each condition is associated with a cell change procedure from a respective cell to the first cell.
8. The method of any one of embodiments 5 to 7, wherein the first cell is a PSCell and the second cell is a target PSCell.
9. The method of any one of embodiments 5 to 7, wherein the first cell is a PCell and the second cell is a target PCell.
10. The method of any one of embodiments 5 to 9, wherein the cell change procedure from the first cell to the second cell is a conditional reconfiguration and further comprising, after executing the cell change procedure to the second cell, storing the conditional reconfiguration to the second cell.
11. The method of any one of embodiments 1 to 4, wherein the first cell is a PSCell belonging to a secondary cell group, SCG, wherein the cell change procedure away from the first cell comprises release of the SCG, and wherein the cell change procedure to the first cell comprises addition of a PSCell.
12. The method of any one of the preceding embodiments, wherein the condition for executing the cell change procedure comprises a condition applied to one or more radio measurements of transmissions by the first cell and/or transmissions by the second cell.
13. The method of embodiment 12, wherein the one or more radio measurements are specified in a measurement configuration that is associated with the first cell and/or the second cell.
14. The method of any one of the preceding embodiments, further comprising, prior to executing the cell change procedure away from the first cell, refraining from monitoring the condition.
15. The method of any one of embodiments 1 to 13, further comprising, prior to executing the cell change procedure away from the first cell, refraining from executing or triggering the cell change procedure to the first cell.
16. The method of embodiment 15, further comprising, prior to executing the cell change procedure away from the first cell, monitoring the condition.
17. The method of any one of the preceding embodiments, wherein the stored configuration comprises a Radio Resource Control, RRC, reconfiguration message for the first cell.
18. The method of any one of the preceding embodiments, further comprising releasing the stored configuration and associated condition responsive to a determination that the user equipment is greater than a threshold distance from a reference location associated with the first cell.
19. The method of any one of the preceding embodiments, further comprising receiving a query message from a network node querying whether the user equipment has stored the configuration and associated condition.
20. The method of any of the previous embodiments, further comprising:
   providing user data; and
   forwarding the user data to a host via the transmission to the network node.

### Group B Embodiments

21. A method performed by a network node, the method comprising:
   configuring a user equipment to associate a stored configuration for a first serving cell with a condition for executing a cell change procedure to the first cell.
22. The method of embodiment 21, wherein the network node is a serving network node for the first cell.
23. The method of embodiment 21 or 22, wherein the cell change procedure away from the first cell comprises a cell change from the first cell to a second cell, and wherein the cell change procedure to the first cell comprises a cell change from the second cell to the first cell.
24. The method of embodiment 23, further comprising configuring the user equipment to associate the stored configuration with a first condition and a second condition, wherein the first condition is for executing the cell change procedure to the first cell from the second cell, and wherein the second condition is for executing a cell change procedure to the first cell from a third cell.
25. The method of embodiment 23, further comprising configuring the user equipment to associate the stored configuration with a plurality of conditions, and wherein each condition is associated with a cell change procedure from a respective cell to the first cell.
26. The method of any one of embodiments 23 to 25, wherein the first cell is a PSCell and the second cell is a target PSCell.
27. The method of any one of embodiments 23 to 25, wherein the first cell is a PCell and the second cell is a target PCell.
28. The method of any one of embodiments 23 to 27, wherein the cell change procedure from the first cell to the second cell is a conditional reconfiguration and further comprising receiving, from the user equipment, after the user equipment has executed the cell change procedure to the second cell, confirmation that the user equipment has stored the conditional reconfiguration to the second cell.
29. The method of embodiment 21 or 22, wherein the first cell is a PSCell belonging to a secondary cell group, SCG, wherein the cell change procedure away from the first cell comprises release of the SCG, and wherein the cell change procedure to the first cell comprises addition of a PSCell.
30. The method of any one of embodiments 21 to 29, wherein the condition for executing the cell change procedure comprises a condition applied to one or more radio measurements of transmissions by the first cell and/or transmissions by the second cell.
31. The method of embodiment 30, wherein the one or more radio measurements are specified in a measurement configuration that is associated with the first cell and/or the second cell.
32. The method of any one of embodiments 21 to 31, further comprising configuring the user equipment to, prior to executing the cell change procedure away from the first cell, refrain from monitoring the condition.
33. The method of any one of embodiments 21 to 31, further comprising configuring the user equipment to, prior to executing the cell change procedure away from the first cell, refrain from executing or triggering the cell change procedure to the first cell.
34. The method of embodiment 33, further comprising configuring the user equipment to, prior to executing the cell change procedure away from the first cell, monitor the condition.
35. The method of any one of embodiments 21 to 34, wherein the stored configuration comprises a Radio Resource Control, RRC, reconfiguration message for the first cell.
36. The method of any one of embodiments 21 to 35, further comprising configuring the user equipment to release the stored configuration and associated condition responsive to a determination that the user equipment is greater than a threshold distance from a reference location associated with the first cell.
37. The method of any of the previous embodiments, further comprising:
   obtaining user data; and
   forwarding the user data to a host or a user equipment.

### Group C Embodiments

38. A user equipment, comprising:
   processing circuitry configured to cause the user equipment to perform any of the steps of any of the Group A embodiments; and
   power supply circuitry configured to supply power to the processing circuitry.
39. A network node, the network node comprising:
   processing circuitry configured to cause the network node to perform any of the steps of any of the Group B embodiments;
   power supply circuitry configured to supply power to the processing circuitry.
40. A user equipment (UE), the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
41. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to receive the user data from the host.
42. The host of the previous embodiment, wherein the cellular network further includes a network node configured to communicate with the UE to transmit the user data to the UE from the host.
43. The host of the previous 2 embodiments, wherein:
   the processing circuitry of the host is configured to execute a host application, thereby providing the user data; and
   the host application is configured to interact with a client application executing on the UE, the client application being associated with the host application.
44. A method implemented by a host operating in a communication system that further includes a network node and a user equipment (UE), the method comprising:
   providing user data for the UE; and
   initiating a transmission carrying the user data to the UE via a cellular network comprising the network node, wherein the UE performs any of the operations of any of the Group A embodiments to receive the user data from the host.
45. The method of the previous embodiment, further comprising:
   at the host, executing a host application associated with a client application executing on the UE to receive the user data from the UE.
46. The method of the previous embodiment, further comprising:
   at the host, transmitting input data to the client application executing on the UE, the input data being provided by executing the host application,
   wherein the user data is provided by the client application in response to the input data from the host application.
47. A host configured to operate in a communication system to provide an over-the-top (OTT) service, the host comprising:
   processing circuitry configured to provide user data; and
   a network interface configured to initiate transmission of the user data to a cellular network for transmission to a user equipment (UE),
   wherein the UE comprises a communication interface and processing circuitry, the communication interface and processing circuitry of the UE being configured to perform any of the steps of any of the Group A embodiments to transmit the user data to the host.
48. The host of the previous embodiment, wherein the cellular network further includes a network node configured to communicate with the UE to transmit the user data from the UE to the host.
49. The host of the previous 2 embodiments, wherein:
   the processing circuitry of the host is configured to execute a host application, thereby providing the user data; and
   the host application is configured to interact with a client application executing on the UE, the client application being associated with the host application.
50. A method implemented by a host configured to operate in a communication system that further includes a network node and a user equipment (UE), the method comprising:
   at the host, receiving user data transmitted to the host via the network node by the UE, wherein the UE performs any of the steps of any of the Group A embodiments to transmit the user data to the host.
51. The method of the previous embodiment, further comprising:
   at the host, executing a host application associated with a client application executing on the UE to receive the user data from the UE.
52. The method of the previous embodiment, further comprising:
   at the host, transmitting input data to the client application executing on the UE, the input data being provided by executing the host application,
   wherein the user data is provided by the client application in response to the input data from the host application.
53. A host configured to operate in a communication system to provide an over-the-top (OTT) service, the host comprising:
   processing circuitry configured to provide user data; and
   a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.
54. The host of the previous embodiment, wherein:
   the processing circuitry of the host is configured to execute a host application that provides the user data; and
   the UE comprises processing circuitry configured to execute a client application associated with the host application to receive the transmission of user data from the host.
55. A method implemented in a host configured to operate in a communication system that further includes a network node and a user equipment (UE), the method comprising:
   providing user data for the UE; and
   initiating a transmission carrying the user data to the UE via a cellular network comprising the network node, wherein the network node performs any of the operations of any of the Group B embodiments to transmit the user data from the host to the UE.
56. The method of the previous embodiment, further comprising, at the network node, transmitting the user data provided by the host for the UE.
57. The method of any of the previous 2 embodiments, wherein the user data is provided at the host by executing a host application that interacts with a client application executing on the UE, the client application being associated with the host application.
58. A communication system configured to provide an over-the-top service, the communication system comprising:
   a host comprising:
   processing circuitry configured to provide user data for a user equipment (UE), the user data being associated with the over-the-top service; and
   a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.
59. The communication system of the previous embodiment, further comprising:
   the network node; and/or
   the user equipment.
60. A host configured to operate in a communication system to provide an over-the-top (OTT) service, the host comprising:
   processing circuitry configured to initiate receipt of user data; and
   a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.
61. The host of the previous embodiment, wherein:
   the processing circuitry of the host is configured to execute a host application, thereby providing the user data; and
   the host application is configured to interact with a client application executing on the UE, the client application being associated with the host application.
62. The host of the any of the previous 2 embodiments, wherein the initiating receipt of the user data comprises requesting the user data.
63. A method implemented by a host configured to operate in a communication system that further includes a network node and a user equipment (UE), the method comprising:
   at the host, initiating receipt of user data from the UE, the user data originating from a transmission which the network node has received from the UE, wherein the network node performs any of the steps of any of the Group B embodiments to receive the user data from the UE for the host.
64. The method of the previous embodiment, further comprising at the network node, transmitting the received user data to the host.

1.-33. (canceled)

34. A method performed by a user equipment, the method comprising:
associating a stored configuration for a first serving cell with a condition for executing a cell change procedure to the first cell, wherein the stored configuration comprises a Radio Resource Control, RRC, reconfiguration message for the first cell;
if the first cell is a serving cell of the user equipment, refraining from monitoring the condition; and
after executing a cell change procedure away from the first cell, monitoring (408) the condition.

35. The method of claim 34, further comprising, upon fulfilment of the condition, executing the cell change procedure to the first cell.

36. The method of claim 34 wherein the cell change procedure away from the first cell comprises a cell change from the first cell to a second cell, and wherein the cell change procedure to the first cell comprises a cell change from the second cell to the first cell.

37. The method of claim 36, wherein the stored configuration is associated with a first condition and a second condition, wherein the first condition is for executing the cell change procedure to the first cell from the second cell, and wherein the second condition is for executing a cell change procedure to the first cell from a third cell.

38. The method of claim 36, wherein the cell change procedure from the first cell to the second cell is a conditional reconfiguration and further comprising, after executing the cell change procedure to the second cell, storing the conditional reconfiguration to the second cell.

39. The method of claim 34, wherein the first cell is a PSCell belonging to a secondary cell group, SCG, wherein the cell change procedure away from the first cell comprises release of the SCG, and wherein the cell change procedure to the first cell comprises addition of a PSCell.

40. The method of claim 34, wherein the condition for executing the cell change procedure comprises a condition applied to one or more radio measurements of transmissions by the first cell and/or transmissions by one or more neighbouring cells.

41. The method of claim 40, wherein the one or more radio measurements are specified in a measurement configuration that is associated with the first cell and/or the one or more neighbouring cells.

42. The method of claim 34, wherein the cell change procedure to the first cell comprises one of: conditional handover, CHO; conditional PSCell change, CPC; and conditional PSCell addition, CPA.

43. A method performed by a network node, the method comprising:
configuring a user equipment to associate a stored configuration for a first serving cell with a condition for executing a cell change procedure to the first cell, wherein the network node is a serving network node for the first cell,
wherein the cell change procedure to the first cell comprises a cell change from a second cell to the first cell, wherein the stored configuration comprises a Radio Resource Control, RRC, reconfiguration message for the first cell; and
configuring the user equipment to, while the first cell is a serving cell of the user equipment, refrain from monitoring the condition.

44. The method of claim 43, further comprising configuring the user equipment to associate the stored configuration with a first condition and a second condition, wherein the first condition is for executing the cell change procedure to the first cell from the second cell, and wherein the second condition is for executing a cell change procedure to the first cell from a third cell.

45. The method of claim 43, wherein a cell change procedure from the first cell to the second cell is a conditional reconfiguration and further comprising receiving, from the user equipment, after the user equipment has executed the cell change procedure to the second cell, confirmation that the user equipment has stored the conditional reconfiguration to the second cell.

46. The method of claim 43, wherein the condition for executing the cell change procedure comprises a condition applied to one or more radio measurements of transmissions by the first cell and/or transmissions by one or more neighboring cells.

47. The method of claim 46, wherein the one or more radio measurements are specified in a measurement configuration that is associated with the first cell and/or the one or more neighboring cells.

48. The method of claim 43, wherein the stored configuration comprises a Radio Resource Control, RRC, reconfiguration message for the first cell.

49. The method of claim 43, wherein the cell change procedure to the first cell comprises one of: conditional handover, CHO; conditional PSCell change, CPC; and conditional PSCell addition, CPA.

50. A user equipment for performing conditional cell change, comprising:
processing circuitry; and
memory storing instructions which, when executed by the processing circuitry, cause the user equipment to:
associate a stored configuration for a first serving cell with a condition for executing a cell change procedure to the first cell, wherein the stored configuration comprises a Radio Resource Control, RRC, reconfiguration message for the first cell;
if the first cell is a serving cell of the user equipment, refraining from monitoring the condition; and
after executing a cell change procedure away from the first cell, monitor the condition.

51. The user equipment according to claim 50, wherein the instructions, when executed by the processing circuitry, further cause the user equipment to, upon fulfilment of the condition, execute the cell change procedure to the first cell.

52. A network node for configuring conditional cell change, the network node comprising:
processing circuitry; and
memory storing instructions which, when executed by the processing circuitry, cause the network node to:
configure a user equipment to associate a stored configuration for a first serving cell with a condition for executing a cell change procedure to the first cell wherein the network node is a serving network node for the first cell;
wherein the cell change procedure to the first cell comprises a cell change from a second cell to the first cell, wherein the stored configuration comprises a Radio Resource Control, RRC, reconfiguration message for the first cell; and
configuring the user equipment to, while the first cell is a serving cell of the user equipment, refrain from monitoring the condition.

53. The network node according to claim 52, wherein the instructions, when executed by the processing circuitry, further cause the network node to configure the user equipment to associate the stored configuration with a first condition and a second condition, wherein the first condition is for executing the cell change procedure to the first cell from the second cell, and wherein the second condition is for executing a cell change procedure to the first cell from a third cell.
